(19) United States
(12) Patent Application Publication
(10) Pub. No.: US 2016/0196360 A1
(43) Pub. Date: Jul. 7, 2016

(54) System and method for searching structured and unstructured data

(71) Applicant: Pricewaterhousecoopers LLP, New York, NY (US)

(72) Inventors: Mitra M. BEST, Beverly Hills, CA (US); Jefferson DELISIO, Mountain View, CA (US); Devin HENKEL, Downers Grove, IL (US); Corynne TUELLER, Rexburg, ID (US)

(73) Assignee: Pricewaterhousecoopers LLP

(21) Appl. No.: 14/757,662

(22) Filed: Dec. 22, 2015

Related U.S. Application Data
(60) Provisional application No. 62/095,739, filed on Dec. 22, 2014.

(51) Int. Cl. G06F 17/30

(52) U.S. Cl. CPC G06F 17/30991

(57) ABSTRACT

A system for searching structured and unstructured data and methods for making and using the same. The system includes an information modeling system for receiving a query, searching one or more data sources based upon the query, and returning a result based upon the searching. The information modeling system advantageously includes an ontology system with a data model for organizing the structured data and unstructured data received from the data sources into one or more entities. The data model thereby can provide a vocabulary for describing each entity. The data model, for example, can describe one or more attributes of a relevant entity and any relationships between the relevant entity and one or more other entities. Thereby, even if the result does not exist directly in the received structured and unstructured data, the system advantageously can determine the result by performing one or more operations on the received data.

### CROSS-REFERENCE TO RELATED APPLICATIONS

This application claims priority to U.S. Provisional Patent Application Ser. No. 62/095,739, filed on Dec. 22, 2014, the disclosure of which is expressly incorporated herein by reference in its entirety and for all purposes.

### FIELD

The disclosed embodiments relate generally to data processing systems and more particularly, but not exclusively, to data processing systems suitable for searching structured and/or unstructured data.

### BACKGROUND

Companies, governments, and other organizations typically manage structured and unstructured data from a variety of data sources. These data sources include data sources internal to a selected organization seeking data as well as data sources external from the selected organization. Since the various data sources are not correlated, conventional approaches to searching the structured and unstructured data available from these data sources are incapable of identifying relationships among the available data. These conventional approaches therefore do not yield comprehensive search results. In view of the foregoing, a need exists for systems and methods for navigating structured and unstructured data sets (e.g., large, disparate, internal, and/or external data sets) via natural language queries and a dynamic user interface to provide unified results and overcome the aforementioned obstacles and deficiencies of conventional search systems.

### BRIEF DESCRIPTION OF THE DRAWINGS

FIG. 1A is an exemplary top-level block diagram illustrating an embodiment of a search system, wherein the search system includes an information modeling system suitable for searching a data source.

FIG. 1B is an exemplary top-level block diagram illustrating an alternative embodiment of the search system of FIG. 1A, wherein the information modeling system is suitable for searching a plurality of data sources.

FIG. 2 is an exemplary block diagram illustrating an embodiment of the information modeling system of FIG. 1B, wherein the information modeling system includes an ontology system, a computation engine system and a document index system.

FIG. 3 is an exemplary block diagram illustrating an alternative embodiment of the information modeling system of FIG. 2, wherein the information modeling system further includes an uniform resource indicator system.

FIG. 4A is an exemplary diagram illustrating an embodiment of a data model for the information modeling system of FIG. 3.

FIG. 4B is an exemplary diagram illustrating an alternative embodiment of a data model for the information modeling system of FIG. 3.

FIG. 5A is an exemplary flow chart illustrating an embodiment of a method by which the information modeling system of FIG. 3 can generate a smart result from a specific incoming query.

FIG. 5B is an exemplary flow chart illustrating an alternative embodiment of the method of FIG. 5A, wherein the information modeling system of FIG. 3 can generate a general result from the incoming query.

FIG. 5C is an exemplary flow chart illustrating another alternative embodiment of the method of FIG. 5A, wherein the information modeling system of FIG. 3 can generate a general result from the incoming query.

FIG. 5D is an exemplary flow chart illustrating yet another alternative embodiment of the method of FIG. 5A, wherein the information modeling system of FIG. 3 can generate a general result from the incoming query.

FIG. 5E is an exemplary flow chart illustrating yet another alternative embodiment of the method of FIG. 5A, wherein the information modeling system of FIG. 3 can generate a general result from the incoming query.

FIG. 5F is an exemplary flow chart illustrating yet another alternative embodiment of the method of FIG. 5A, wherein the information modeling system of FIG. 3 can generate a general result from the incoming query.

FIG. 6 is an exemplary block diagram illustrating an alternative embodiment of the information modeling system of FIG. 3, wherein the information modeling system further includes a user interface system.

FIG. 7 is an exemplary flow chart illustrating an embodiment of a method by which the information modeling system of FIG. 6 can generate a result from an incoming query.

FIG. 8 is an exemplary diagram illustrating an embodiment of an interface architecture for the information modeling system of FIG. 6.

FIG. 9A is an exemplary diagram illustrating an embodiment of a method by which the information modeling system of FIG. 6 can ingest structured data.

FIG. 9B is an exemplary diagram illustrating an embodiment of a method by which the information modeling system of FIG. 6 can ingest unstructured data.

FIG. 10A is an exemplary detail diagram illustrating another alternative embodiment of the information modeling system of FIG. 3.

FIG. 10B is an exemplary block diagram illustrating yet another alternative embodiment of the information modeling system of FIG. 3, wherein the information modeling system further includes an authentication system, a data preparation system, and a connector system.

FIG. 10C is an exemplary flow chart illustrating an embodiment of a method by which the information modeling system of FIG. 10B can begin to receive an incoming query.

FIG. 11A is an exemplary detail drawing illustrating an embodiment of a result presented by the information modeling system of FIG. 3 in response to a specific query about an identified person.

FIG. 11B is an exemplary detail drawing illustrating another embodiment of a result presented by the information modeling system of FIG. 3 in response to a specific query about an identified person.

FIG. 11C is an exemplary detail drawing illustrating an embodiment of a result presented by the information modeling system of FIG. 3 in response to a specific query about an identified skill.

FIG. 11D is an exemplary detail drawing illustrating an alternative embodiment of the result presented in FIG. 11C.

FIGS. 11E-K are exemplary detail drawings each illustrating an embodiment of a result presented by the information modeling system of FIG. 3.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

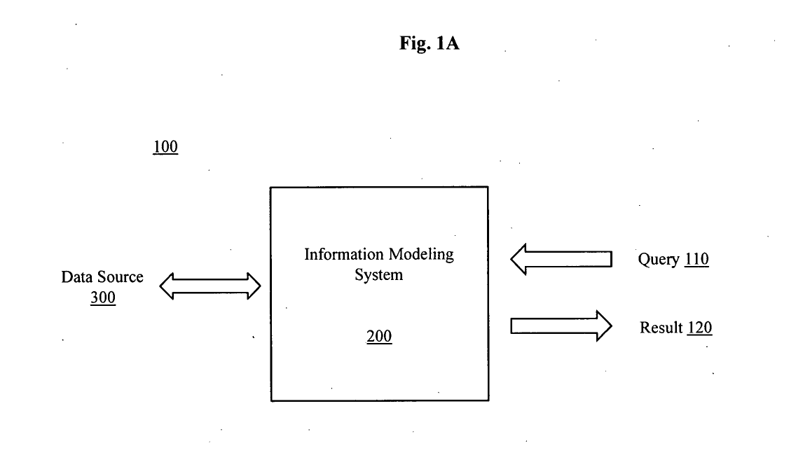

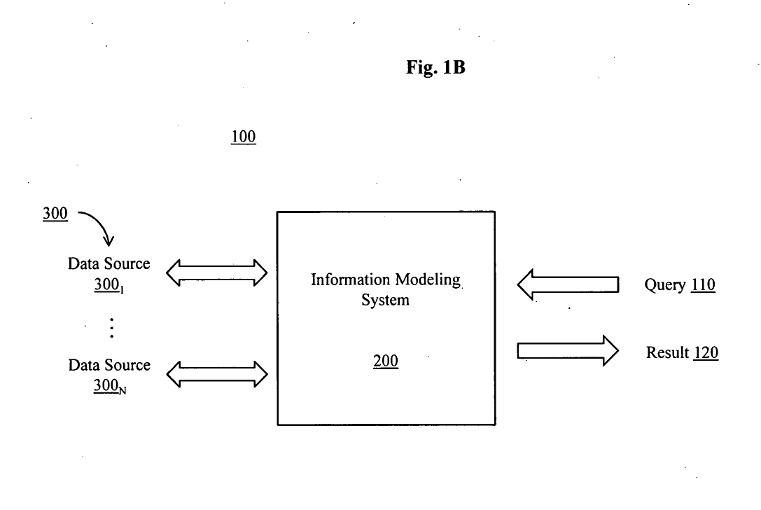

Since currently-available searching architectures are incapable of identifying relationships among data available from disparate data sources, a search system and method that models structured and unstructured data, enables modular construction of new information groupings, and otherwise enhances an ability to locate information can prove desirable and provide a basis for a wide range of search applications, such as searches for individuals, companies and other entities and for any relationships among the same. This result can be achieved, according to one embodiment disclosed herein, by a search system 100 as illustrated in FIG. 1A.

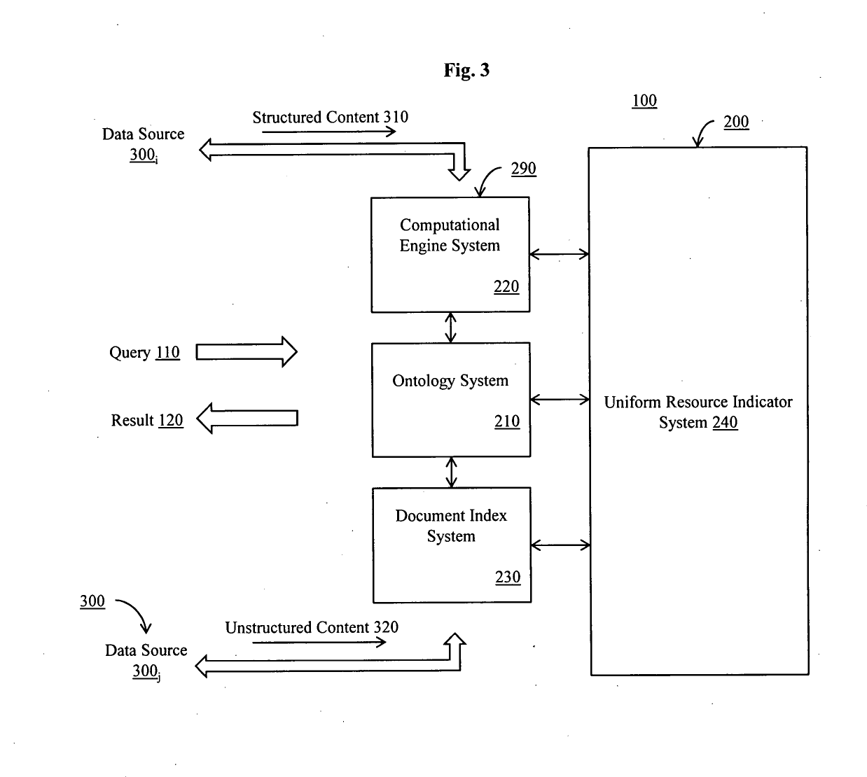

Turning to FIG. 1A, the search system 100 is shown as including an information modeling system 200. The information modeling system 200 can communicate with a data source 300 and thereby can receive data (or content) from the data source 300. The data source 300 can comprise any conventional source of data and other information. Exemplary data sources can include databases, web sites, comma separated values (CSV) files, extensible markup language (XML) files, SharePoint® applications, application program interface (API) files, Web Method calls, and/or documents without limitation. The data available from the data source 300 can include structured data (or content) 310 and/or unstructured data (or content) 320 (collectively shown in FIG. 3). The structured data 310 is data that is supported by other information. For example, the structured data 310 can include metadata that describes a nature of the structured data. Exemplary metadata can include a name, a location, and/or a format (e.g., a number and/or a delimited text field) for identifying a data type for the structured data 310. The metadata preferably can include unique identifiers of selected structured data. For example, metadata can include a role of an individual (e.g., whether a company is a client or whether an individual is a manager).

The unstructured data 320, in contrast, is data that typically is provided in free form with a limited amount of information, if any, about the unstructured data 320. Examples of unstructured data 320 can include textual data, such as documents, tweets, discussion threads, blogs, and/or web pages, without limitation. Although shown and described in terms of structured data 310 and/or unstructured data 320 for purposes of illustration only, the received data can comprise any suitable data or other content received from the content source, including semi-structured data. For purposes of clarity, it is understood that the unstructured data 320 can include the semi-structured data as well as any other data, except the structured data 310, that is received from the content source 300. By combining the unstructured data 320 with the structured data 310, the search system 100 can provide a rich body of content that can be queried.

The information modeling system 200 advantageously can model the data received from the data source 300. By modeling the received data, the information modeling system 200 can enable a modular construction of new information groupings of the data, increase an ability to locate information within the data, provide a computational transformation of the information, and/or support pivot browsing of the modeled data. The information modeling system 200 thereby can support identification of information within the modeled data at a granular level and/or within a context associated with a system user's mental model for structure. In other words, the information modeling system 200 can emulate the manner by which the system user organizes a selected process and/or task.

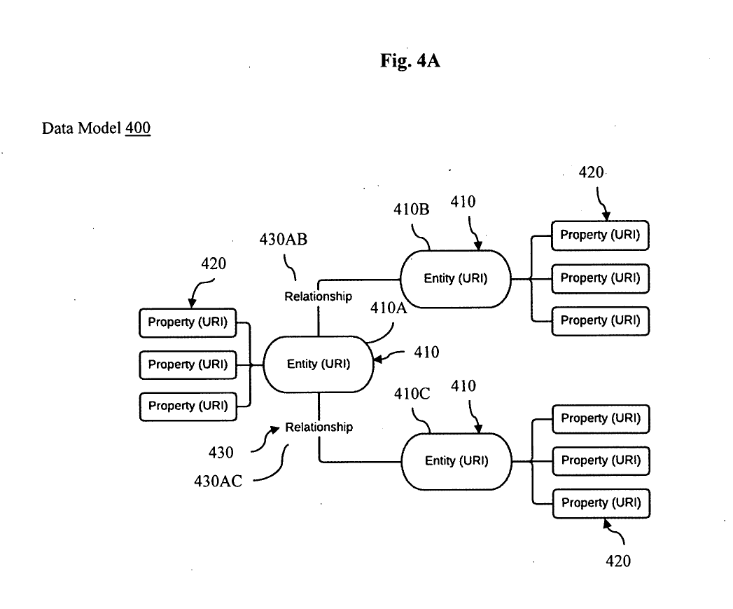

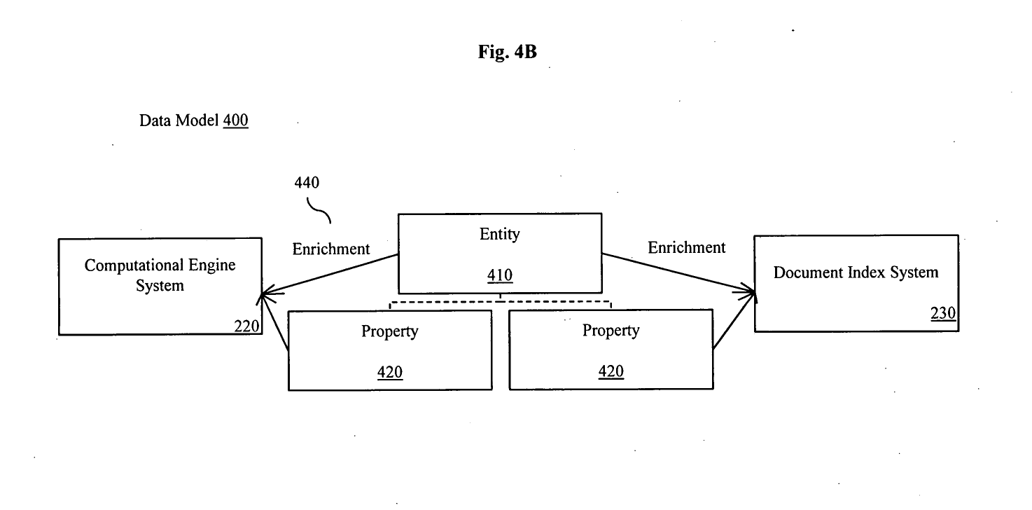

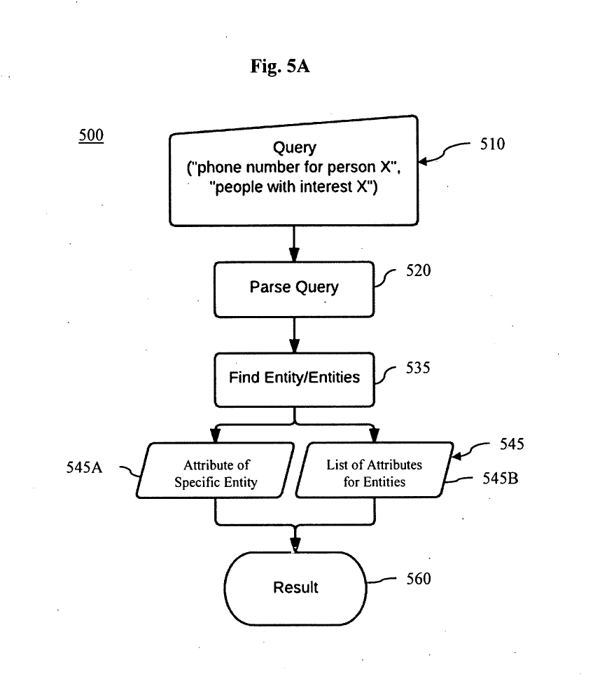

In one embodiment, the information modeling system 200 can be associated with a predetermined organization, and the data source 300 can be internal to, and/or external from, the predetermined organization. Accordingly, the information modeling system 200 advantageously can model the data received from the data source 300 based on specific needs of the predetermined organization to reflect a set of questions specifically tailored for the predetermined organization. For example, information modeling system 200 can model the received data based upon one or more business entities 410 (shown in FIG. 4A) within the predetermined organization. The selected entities 410 can include, for example, employees, clients, products, and/or services without limitation, and the information modeling system 200 can assign a unique identifier to each entity 410. In one example, the modeling can be flexible to support a situation in which a selected business entity 410 wishes to quickly bring up information about one or more companies, people, and/or skills (e.g., “who is on the board of company X” and/or “how many companies have boards”).

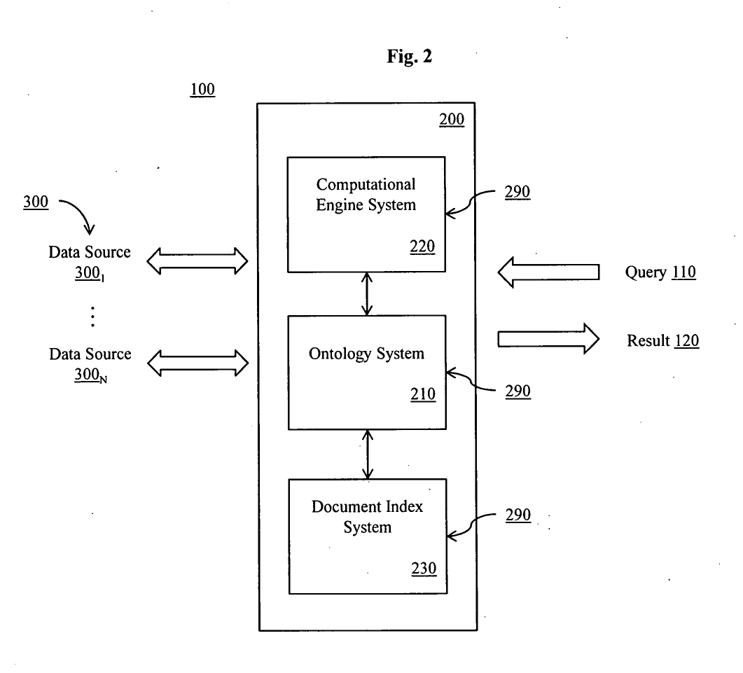

If the information modeling system 200 comprises a plurality of processing platforms 290 (shown in FIG. 2), the unique identifier advantageously can identify the associated entity 410 across the processing platforms 290. Stated somewhat differently, the unique identifier can be shared among different processing platforms 290, which can work in concert to generate a coherent view of the information available from the data source 300. The processing platforms 290 thereby can index, compute and/or organize the received data from the data source 300. By indexing the received data, the information modeling system 200 can generate an abstraction of the received data by identifying selected received data that relate to a preselected concept and linking the selected received data.

Advantageously, one or more additional processing platforms 290 can be included with the information modeling system 200. Each additional processing platform 290 can provide additional technology and/or functionality to the information modeling system 200 and preferably includes an ability to share the unique identifiers with the other processing platform(s) 290 of the information modeling system 200. Each processing platform 290 thereby can be technology-agnostic and capable of supporting any technology that can accept the unique identifiers as an input and can provide information that is identified as being relevant to the accepted unique identifiers.

The information modeling system 200 of FIG. 1A is illustrated as being configured to receive a query 110 and/or to provide a result 120 in response to the query 110. The information modeling system 200 can receive the query 110 in any conventional manner, including, for example, textually via a keyboard and/or orally via a microphone system. In one embodiment, the query 110 can be typed into a form field on a web page and submitted to the information modeling system 200 by hitting the return key or clicking on presented submission indicia. The result 120 likewise can be presented in any conventional manner, including, for example, visually via a display system and/or orally via a speaker system. In a preferred embodiment, the result 120 can be presented in a modular (or grouped) manner. The presentation of the result 120 thereby can be advantageously arranged (or organized) in a manner that is consistent with the query 110.

In operation, the information modeling system 200 can parse the query 110 to identify an entity 410 that is relevant to the query 110. The unique identifier for the identified entity 410 can be provided to each processing platform 290 of the information modeling system 200. Each processing platform 290 can provide available information for the identified entity 410. The information modeling system 200 evaluates and modularly combines the provided information from each processing platform 290 to dynamically create the result 120. The result 120 advantageously can comprise information views that include retrieved data from the data source 300 and/or computed data from one or more of the processing platforms 290. The information views can be organized to support a selected user task and/or include an ability to access other information views related to the result 120. Although system operation is described with reference to a query 110 that relates to a single entity 410 for purposes of illustration only, the query 110 can relate to any suitable number of entities 410, and information modeling system 200 can evaluate and modularly combine the provided information for each identified entity 410 to dynamically create the result 120.

Turning to FIG. 1B, an alternative embodiment of the search system 100 of FIG. 1A is shown. The information modeling system 200 of FIG. 1B is illustrated as being able to communicate with a plurality of data sources 300₁, . . . , 300_{N} and thereby can receive data (not shown) from each of the data sources 300 in the manner discussed in more detail above with reference to FIG. 1A. The search system 100 can include any suitable number N of data sources 300 that can be constant and/or vary over time, and each data source 300 can be disparate from the other data sources 300 and/or can be at least partially integrated with another data source 300. The data available from a selected data source 300 can include the structured data (or content) 310 and/or unstructured data (or content) 320 (collectively shown in FIG. 3) as discussed above.

The search system 100 of FIG. 1B advantageously can evaluate the query 110 and modularly combine the provided information from each of the data sources 300 for each identified entity 410 to dynamically create the result 120. As will be discussed in further detail, the information modeling system 200 can establish one or more relationships among the modular data to provide an intelligent solution to the initial query. For example, the query 110 can include: “Jane Doe's phone number.” The search system 100 advantageously can provide the result 120 to this query in a modular (or grouped) manner based on the understanding of the relationships between the underlying data. The result 120 can include not only a directed response (e.g., Jane Doe's phone number), but also any relevant data available from a selected data source 300. In this example, the system 100 can provide an “answer” card in the result 120 that includes additional contact information for Jane Doe (e.g., office location, electronic mail address, instant messenger link, and so on). In some embodiments, the answer card can be separate from, or included, in the result 120.

In another example, if the information modeling system 200 identifies two entities 410 in the query 110, the search system 100 can recognize not only that specific information related to the identified entities 410 is desired, but also that a comparison relationship may be desired. Accordingly, the result 120 from the search system 100 can include the directed result in addition to a split screen comparison of the identified entities 410.

In yet another example, if the information modeling system 200 identifies a specific location (e.g., New York) and a skill (e.g., Cloud computing) being used with natural language such as “who knows” or “who has” in the query 110, the search system 100 can identify both information directly responsive to the query and related information from the data sources 300. Accordingly, the search system 100 can return a card that has a list of people who have those skills associated with them and other things related to the terms, such as documents about Cloud computing or references to work done in New York relevant to Cloud computing.

FIG. 2 is a block diagram that illustrates an exemplary embodiment of the information modeling system 200. As shown in FIG. 2, the information modeling system 200 can include a plurality of exemplary processing platforms 290. The processing platforms 290 can comprise uniform and/or different processing platforms. Preferably, each processing platform 290 preferably is capable of operating on a different type of data than the other processing platforms 290, indexing and/or applying transformations to the data as needed. Each of the processing platforms 290 can communicate and otherwise cooperate with at least one other processing platform 290 either directly and/or indirectly via an intermediate system, such as an intermediate processing platform 290. Although the information modeling system 200 can include any suitable number and/or selection of processing platforms 290 depending upon a selected system application, the information modeling system 200 of FIG. 2 includes an ontology system 210, a computational engine system 220 and/or a document index system 230.

The ontology system 210 is a processing platform 290 that includes a data model for organizing the received structured data (or content) 310 and/or unstructured data (or content) 320 (collectively shown in FIG. 3) into one or more entities 410 (shown in FIG. 4A). The data model thereby can provide a vocabulary for describing each entity 410. The data model, for example, can describe one or more attributes (and/or characteristics and/or properties) of a relevant entity 410 and/or any relationships between the relevant entity 410 and one or more other entities 410. Stated somewhat differently, each entity 410 can comprise a node (or intersection) in the ontology system 210 and can be defined in terms of its properties (or metadata) and/or its relationship with other entities 410.

The ontology system 210 advantageously can organize the received data 310, 320 into a model that reflects organizational thinking about the manner by which the received data 310, 320 relates to the entities 410 and the manner by which the entities 410 relate to each other. The ontology system 210 thereby can provide a semantic layer to the information modeling system 200 by building upon how a user understands the meanings of selected terms and the relationships among the selected terms.

The computational engine system 220 is a processing platform 290 of the information modeling system 200 and provides an ability to compute a result 120 that does not exist directly in the received structured data 310 and/or unstructured data 320. In other words, the computational engine system 220 can determine the result 120 by performing one or more operations on the received data 310, 320. Other exemplary features of the computational engine system 220 can include one or more of natural language processing, internal and/or external lookups of structured data 310 and/or unstructured data 320, post-query computation, and data visualization.

The document index system 230 is a processing platform 290 of the information modeling system 200 and can receive the unstructured data 320 from the data source 300. In one embodiment, the document index system 230 focuses on underlying data that primarily consists of documents. Ingesting repositories of documents and other digital content, the document index system 230 can create an index for the ingested content. The index permits the ingested content to be rapidly retrieved in response to a query 110.

The information modeling system 200 can include any suitable collection and/or arrangement of processing platforms 290. The collection and/or arrangement of processing platforms 290 can be determined, for example, based upon a selected system application. Other exemplary processing platforms 290 can include one or more of a news service system (not shown) to process received data 310, 320 in the form of a news feed that relates to the entities 410 and/or a social media engine system (not shown) for analyzing structured data 310 and/or unstructured data 320 in the form of social media streams and return the result 120 in the form of a social media feed (e.g., Facebook® post and/or Twitter Tweet®).

Although each processing platform 290 is shown and described herein as being separate and distinct from the other processing platforms 290 for purposes of illustration only, two or more of the processing platforms 290 can be at least partially integrated. In other words, a selected processing platform 290 can perform at least a subset of the functions attributed to each of a selected plurality of processing platforms 290. Two or more of the ontology system 210, the computational engine system 220 and/or the document index system 230, for example, can be at least partially integrated with each other.

Turning to FIG. 3, the information modeling system 200 is shown as advantageously including an Uniform Resource Indicator (URI) system 240. A URI is a unique code and can comprise the unique identifier that is assigned to each entity 410 (shown in FIG. 4A). Advantageously, the URI can enable the document index system 230 to be at least partially integrated with at least one other processing platform 290 of the information modeling system 200. The document index system 230, for example, can be at least partially integrated with the other processing platform 290 via entity extraction from the received data 310, 320 and/or URI tagging of the index entries. The received unstructured data 320 thereby can be rapidly retrieved in response to a query 110 that identifies at least one entity 410. In this case, the document index system 230 can implement a predetermined set of rules (or priorities) based on the shared URIs identified from the query 110. For example, the predetermined set of rules can prioritize documents where an identified person is an author over documents where the identified person is merely mentioned.

The unique identifier thereby can provide a common vocabulary that is shared by each processing platform 290 of the information modeling system 200. This vocabulary can provide one way to relate specific entities 410 and the properties and/or relationships associated with the specific entities 410 across the different technologies so that each technology can be confident that it is referring to the same conceptual object. To illustrate, consider the complexity of maintaining information about a person where the information can be coming from multiple data sources 300 in both structured and unstructured format. The search system 100 advantageously can manage people as entities with structured data mapped to that entity as properties. The search system 100 likewise can process unstructured data 320 and create a map to all data 310, 320 and other content that includes a specific entity or any properties of the specific entity. These mappings are created using the unique identifiers so that all references to an entity in the search system 100 share a common name for that entity.

When provided as URIs, the unique identifiers can take the form of “http://domain.com/GUID” and preferably are unique for each entity and/or property. At the point of query, multiple ways exist to ask for a piece of information. For example: “Jane Doe's phone number,” “Telephone for Jane Doe,” and “Jane Doe's office phone” are all ways to ask for the same piece of information. Synonyms for properties are also encoded with the unique identifiers so that the information modeling system 200 can quickly identify the specific query 110 and request information from the partner technologies to assemble a relevant result 120.

Additionally and/or alternatively, the Uniform Resource Indicator system 240 advantageously can be used to identify a relationship between a relevant entity 410 and properties (or metadata) associated with the relevant entity 410. The metadata associated with the relevant entity 410 can include any unstructured data 320 that is associated with the relevant entity 410. The Uniform Resource Indicator system 240 thereby can establish relationships between the structured data 310 and the unstructured data 320 that is associated with the relevant entity 410. In other words, the Uniform Resource Indicator system 240 advantageously can identify one or more entities 410 associated with the received structured and unstructured data 310, 320, enabling the information modeling system 200 to identify specific data and other content about each entity 410.

During ingest, the structured data 310 can be processed and mapped by the ontology system 210. The structured data 310, once mapped, can be associated with respective unique identifiers, such as URIs. The unique identifiers enable relationships to be identified among the mapped data. Thereby, if the structured data 310 identifies a person, for example, the person can be associated with a unique identifier. Then, other structured data 310, such as a document authored by the person, that includes the person's name can be associated with the unique identifier of the person. Other structured content in this example can include the person's work history, a formal list of skills, their résumé, and so on. The ontology system 210 preferably shares the unique identifiers with the computational engine system 220, enabling the computational engine system 220 to perform calculations and other processes on queries 110 that include natural language descriptions for entities 410.

The document index system 230 ingests the unstructured data 320. In one embodiment, the document index system 230 uses a crawling process for identifying unstructured data 320. The document index system 230, for example, can crawl web sites and other data sources 300 that include linked data by following the data links. The document index system 230 typically can begin the crawling process by starting at a central home page and then progressing to other web pages that support the central home page. All of the content available on the central home page and the other supporting web pages thereby can be accessed by the document index system 230.

While crawling the unstructured data 320, the document index system 230 analyzes the crawled content for references to any entity 410 that has been previously identified by the ontology system 210. Upon identifying crawled content that references a previously-identified entity 410, the document index system 230 can create a relationship between the crawled content and the previously-identified entity 410 and can share information about the relationship with the other processing platforms 290 of the information modeling system 200. The ontology system 210, for example, includes URIs that are associated with specific entities 410 and that identify a relationship between the specific entities 410 and other content and/or data sets. The data sets can comprise different data sources 300. In other words, the ontology system 210 can enable the information modeling system 200 to incorporate data 310, 320 from a wide range of diverse data sources 300.

The URIs can help to ensure that the entities 410 are correctly identified across the data sources 300. Additionally and/or alternatively, the URIs can identify a specific entity 410 that is referenced in the crawled data. The document index system 230 thereby can use the URIs to form a relationship between selected crawled data and the specific entity 410 and to provide any data artifacts related to the specific entity 410. The computational engine system 220 likewise can use the URIs to perform a computation transformation by gathering specific information from the selected crawled data associated with the specific entity 410.

The processing platforms 290 of the information modeling system 200 advantageously can be synchronized by sharing the unique identifiers, such as the URIs, among the processing platforms 290. The ontology system 210 preferably keeps track of the unique identifier of each of the entities 410 and to provide the unique identifiers and the metadata and other properties to the other processing platforms 290. Advantageously, relationships between the entities 410 can be represented in the ontology system 210 by matching properties from a first entity 410 to the properties of another entity 410. For example, a property of a selected person can be a job that the person previously held and that is subsequently related to a company. By following this chain, the relationship “person has worked at company” can be inferred.

As another example, a property of a selected person can include one or more engagements in which the person was involved while employed at a company. In addition to the relationship between the person and a selected engagement, the relationship between the selected engagement and associated teammates can also be inferred. The result 120 therefore can provide the information for related entities 410 such as the associated teammates and companies of the selected person. In some embodiments, the selected engagement can be represented by its own entity 410 and displayed with its own view showing a respective team of employees, statistics, and other related engagements, for example.

Although the URIs for the received structured data 310 preferably are generated contemporaneously as the ontology system 210 records the received structured data 310 and the URIs for the received unstructured data 320 preferably are generated contemporaneously as the document index system 230 indexes the received unstructured data 320, the URIs for the received data 310, 320 can be generated at any suitable time. The URIs and other metadata for the received data 310, 320 can supplement the data indices and/or can be used to tag the query 110 as the query 110 is parsed and otherwise processed by the computational engine system 220.

In one embodiment, the unique identifier tagging can be driven by the structured data 310. The computational engine system 220 can analyze the structured data 310 to identify the structured data 310 associated with one or more known entities 410, properties 420, and/or relationships 430. The computational engine system 220 can provide the identified structured data 310 to the ontology system 210, which can assign unique identifiers to the identified structured data 310. Additionally and/or alternatively, the document index system 230 can analyze the unstructured data 320. If any unstructured data 320 is identified as being associated with one or more known entities 410, properties 420, and/or relationships 430, the document index system 230 can provide the identified unstructured data 320 to the ontology system 210, which can assign unique identifiers to the identified unstructured data 320. Advantageously, the information modeling system 200 can analyze a query 110 to identify any entity 410 that is associated with the query 110. The information modeling system 200 thereby can associate the unique identifier of the identified entity 410 with the query 110. The query 110 with the unique identifier of the identified entity 410 can be provided with one or more processing platforms 290 of the information modeling system 200. The processing platforms 290 thereby can attempt to provide information relevant to the query 110. Any information provided by the processing platforms 290 in response to the query 110 preferably includes unique identifiers with the provided information.

For purposes of illustration only, the information modeling system 200 is shown as receiving the structured data (or content) 310 from a first selected data source 300ᵢ and the unstructured data (or content) 320 from a second selected data source 300ⱼ; however, the information modeling system 200 of FIG. 3 is suitable for use with, and for receiving data 310, 320 from, any suitable number N of the data sources 300 in the manner discussed in more detail above with reference to FIG. 1B. For purposes of illustration only, the information modeling system 200 is shown as receiving the structured data (or content) 310 from a first selected data source 300ᵢ and the unstructured data (or content) 320 from a second selected data source 300ⱼ; however, the information modeling system 200 of FIG. 3 is suitable for use with, and for receiving data 310, 320 from, any suitable number N of the data sources 300 in the manner discussed in more detail above with reference to FIG. 1B.

The data sources 300 can also represent any number of applications, each having a predetermined function. For example, a new application can be implemented that uses virtual reality technology—such an application can be used to present an overview of a company's clients. The new application can receive a list of clients and a unique identifier for indexing. Accordingly, each data source 300 can contribute additional information (not shown) to the information modeling system 200 to describe the values that the application is returning (e.g., a value, a list, a graphic, and so on). When the result 120 is to be displayed, a template and/or style sheet, discussed below, can determine how to provide the information based on the values that the application returns.

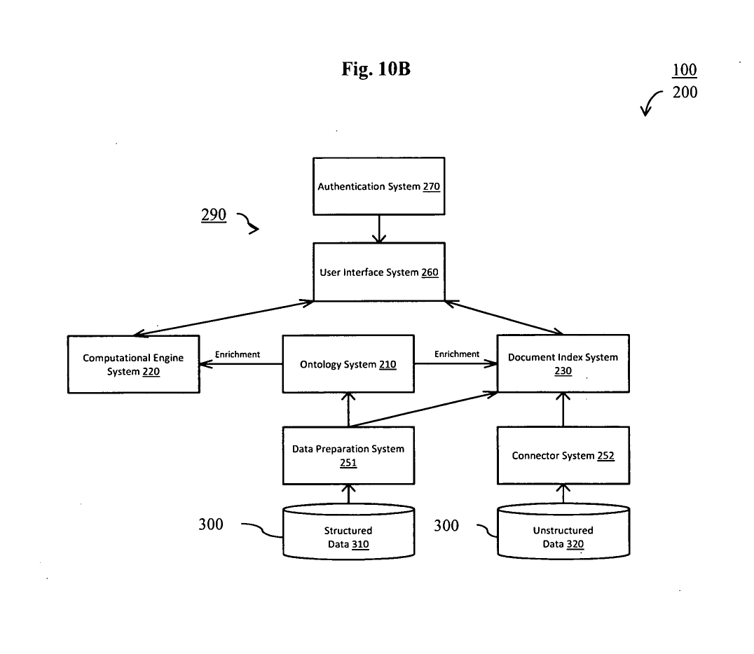

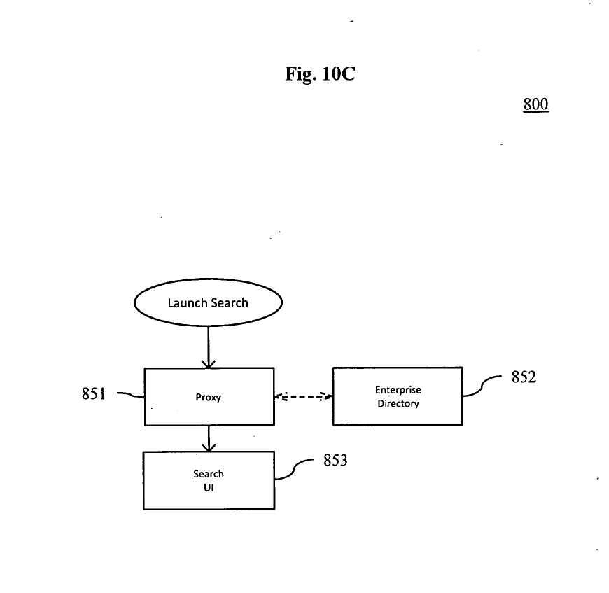

Turning briefly to FIG. 10A, an exemplary detail diagram illustrating an alternative embodiment of the information modeling system 200 is shown. The ontology system 210, the computational engine system 220, and the document index system 230 (collectively shown in FIG. 3) of the information modeling system 200 are involved in creating the index and providing the response 120 to the query 110. The information modeling system 200 thereby can support flexible querying and/or complex results.

FIG. 10A shows an embodiment of the indexing process performed by the information modeling system 200. The indexing process enables the information modeling system 200 to create deep linkages among the processing platforms 290 and/or to support multi-part querying of the data 310, 320. In the first stage of FIG. 10A, the data 310, 320 received from the data source(s) 310 is indexed by one or more appropriate processing platforms 290 and a unique identifier is associated with each relevant entity 410. The unique identifier(s) can be shared among the various processing platforms 290. By sharing the unique identifier(s) among the various processing platforms 290, the information modeling system 200 advantageously can ensure that the result 120 will include a predetermined amount, and preferably all, of the relevant data and other content for the associated query 110.

FIG. 4A illustrates an embodiment of a data model 400 for the information modeling system 200. The exemplary data model 400 shown in FIG. 4A includes three entities 410A, 410B, 410C. Each of the entities 410A, 410B, 410C is shown as being associated with respective pluralities of properties 420, each including the URIs and other metadata. The data model 400 also identifies relationships 430 among the entities 410A, 410B, 410C. As illustrated in FIG. 4A, a first relationship 430AB is identified between the entity 410A and the entity 410B; whereas, a second relationship 430AC is identified between the entity 410A and the entity 410C. Although shown and described as comprising three entities 410A, 410B, 410C with three properties 420 and selected relationships 430 for purposes of illustration only, the data model 400 can include any suitable number of entities 410 each having any predetermined number of properties 420 and any selected number of relationships 430 with one or more other entities 410. The predetermined number of properties 420 for each entity 410 can be the same and/or different among the entities 410, and the selected number of relationships 430 for each entity 410 can be the same and/or different among the entities 410.

FIG. 4B illustrates an alternative embodiment of the data model 400 shown in FIG. 4A. For purposes of illustration only, one entity 410 is shown as being associated with respective properties 420. FIG. 4B also illustrates an enrichment 440, which is an interchange protocol to ensure that the different processing platforms 290 of the information modeling system 200 are consistent in the way they refer to concepts (e.g., types of entities 410, specific entities and their properties) within the search system 100. For instance, if a person has a unique identifier in the ontology that is passed to the document index system 230 and the computational engine system 220, the person can be identified in the query 110 such that their properties are available for computations and any documents in the document index system 230 that should be included in the result 120. Although shown and described as comprising one entity 410 with two properties 420 and selected enrichment 440 for purposes of illustration only, the data model 400 can include any suitable number of entities 410 each having any predetermined number of properties 420 and any selected number of enrichment 440 protocols.

The ontology system 210 (shown in FIG. 3) can apply the data model 400 to represent entities 410 and relationships 430 among the entities 410. The entities 410 can comprise coherent collections of data 310, 320 that is meaningful in the aggregate. The entities 410 likewise can have relationships 430 to other entities 410. If the entity 410 comprises a person, for example, the person can be represented as a collection of data 310, 320 that is related to the person and/or that relates the person to another entity 410 in a meaningful way (e.g., “A person lives in a city,” “A person has a set of skills,” “A person has authored X papers,” and “A person has worked at a company”). Given the set of related entities 410, relationships can be established to answer both simple and complex queries (e.g., “A person with skill Y who has performed work at Company Z of type B” and “Are there any managers or above with Cloud computing experience in the financial industries?”).

A property 420 of an entity 410 can include the underlying data 310, 320 that defines the entity 410. Each property 420 of the entity 410 can provide a relationship (or linkage) 430 to one or more other entities 410. Returning to the example in which the entity 410 comprises a person, illustrative properties 420 for the person can include the name, phone number, and/or job title of the person. The relationships 430 among the entities 410 can be represented in the ontology system 210 by matching the properties 420 from a selected entity 410 to the properties 420 of another entity 410. Again returning to the example in which the entity 410 comprises a person, a property 420 of the person can be a job that the person previously held and that subsequently is related to a company. By following the chain of relationships 430, the relationship “person has worked at company” can be inferred.

The computational engine system 220 preferably includes an ability to compute a result 120 from an incoming query 110 even if the result 120 does not exist directly in the received structured data (or content) 310 and/or unstructured data (or content) 320 (collectively shown in FIG. 3). In other words, the computational engine system 220 advantageously can determine the result 120 by performing one or more operations on the received data 310, 320.

Upon receiving the query 110, the computational engine system 220 can use the input interpretation to scan the knowledge domains for information for responding to the query 110 directly. For example, if the query 110 includes a request for a person's phone number, the computational engine system 220 can interpret the person's name as a pointer to an entity 410 of the type “person,” can look for that person in the structured data 310, and can find the field of type “phone number.” If successful, the computational engine system 220 can respond with the data in the field “phone number,” the unique identifier (or URI) for the data type “phone number,” and the unique identifier (or URI) for the person identified in the query 110.

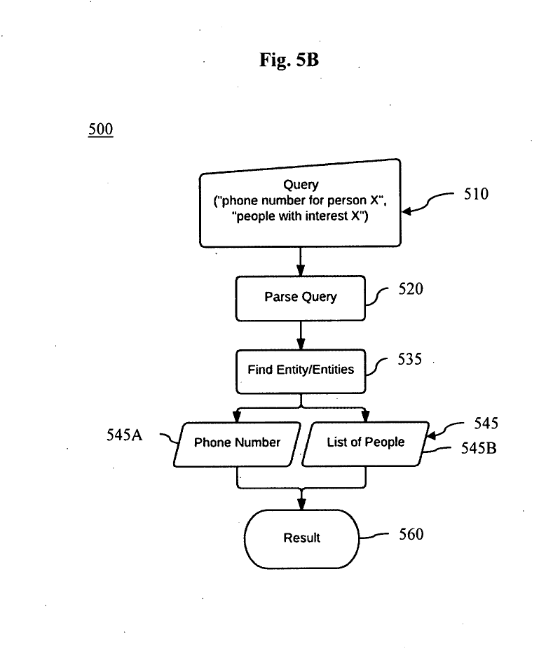

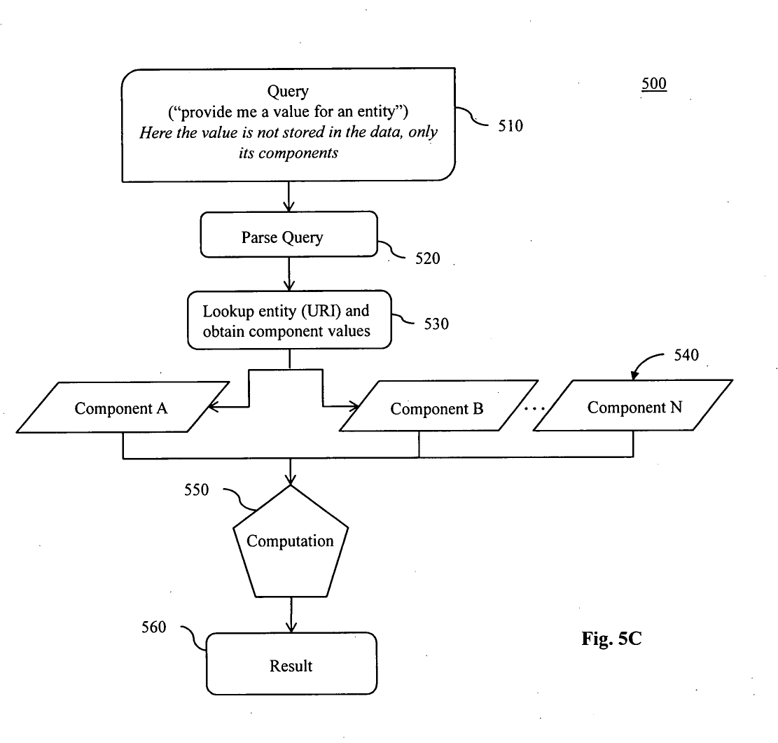

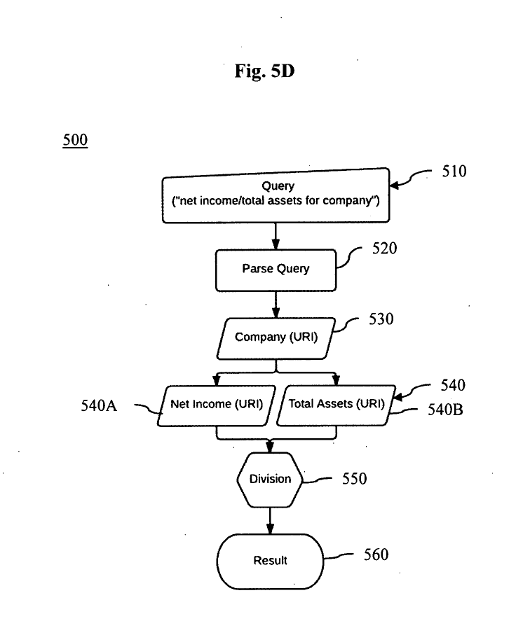

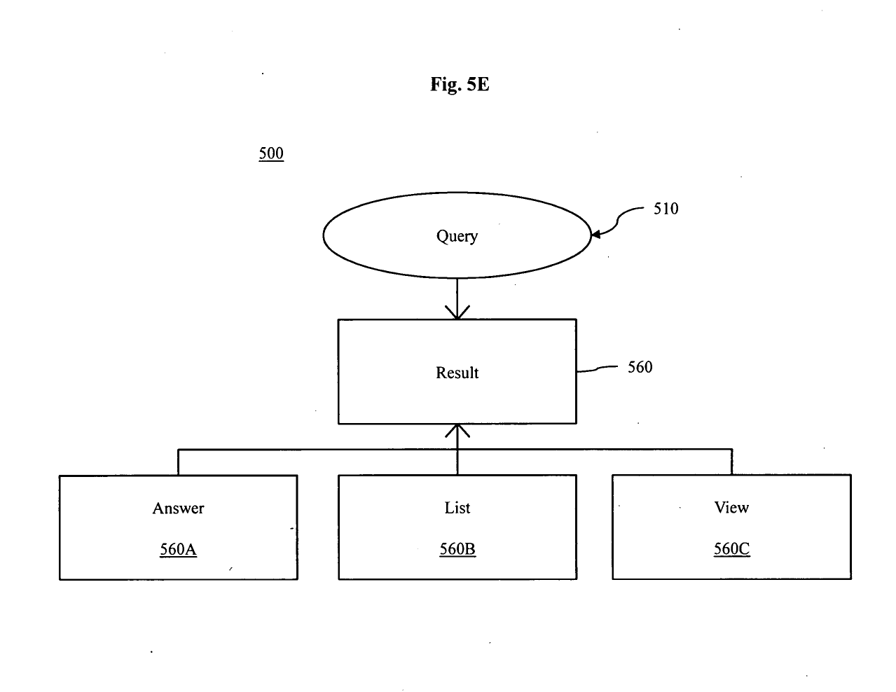

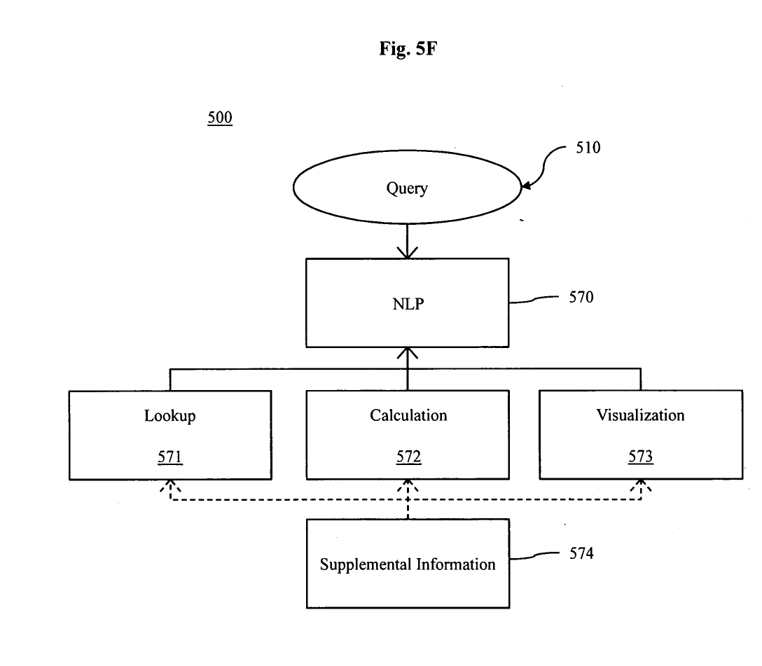

An embodiment of a method 500 by which the computational engine system 220 (shown in FIG. 2) can generate a specific result 120 to an incoming query 110 is illustrated in FIG. 5A. The computational engine system 220, at 510, can receive the query 110. For purposes of illustration, the query 110 can include a question to be answered by the search system 100 (shown in FIG. 2). Here, the query 110 is shown as being a question that requests specific information and that is presented as a natural language question. The illustrated questions are “phone number for person X” and “people with interest X.” As previously discussed, the user can enter the text in any method as desired and includes an “auto-fill” feature with suggested queries. The method 500 advantageously enables generation of a smart result for the specific question.

The computational engine system 220, at 520, can parse the query 110. In other words, the computational engine system 220 can parse the natural language question into actionable input interpretations. Additionally and/or alternatively, parsing the query 110, at 520, can include parsing the query 110 to identify one or more entities 410 (shown in FIG. 4A), at 535. In some embodiments, although not shown, parsing the query 110 can include determining the entities 410 that are involved, whether there is a recognizable pattern (e.g., an address, a skill, a person), what actions are to be taken with the entities 410 and the properties 420, and how the result 120 will be displayed to the user. For example, identified entities 410 can be mapped into existing entities in order to determine the type of the entity. If there is a direct match, then the entity 410 is tagged with the URI, which is sent along to all other components in the information modeling system 200.

Responsive data, such as a telephone number 545A and/or a list of individuals 545B (collectively shown in FIG. 5B), thereby can be extracted (or identified), at 545, from the received structured data 310 (shown in FIG. 3) and/or unstructured data 320 (shown in FIG. 3). Although shown and described with reference to a telephone number 545A and/or list of individuals 545B in FIG. 5B, responsive data can include any attribute related to a particular entity as shown in FIG. 5A. At 560, the responsive data can be used to generate the smart result 120.

An alternative embodiment of the method 500 by which the computational engine system 220 (shown in FIG. 2) can generate a general result 120 is illustrated in FIG. 5C. The computational engine system 220, at 510, can receive the query 110. For purposes of illustration, the query 110 can include a question to be answered by the search system 100 (shown in FIG. 2). As shown in FIG. 5D, the query 110 is shown as being a question “net income/total assets for company?” that is presented as a natural language question.

Returning to FIG. 5C, some queries 110 can involve the information modeling system 200 identifying multiple pieces of data 310, 320 and performing at least one operation on the data 310, 320 in order to generate the result 120. For instance, two different pieces of financial information can be used to complete a mathematical computation (sums, ratios, etc.). If the computational engine system 220 identifies that a selected query 110 can include a computation as part of the result 120, the computational engine system 220 can retrieve the individual properties 420 associated with the data 310, 320 and perform the computation. The computational engine system 220 can provide the result of the computation, along with the unique identifiers (or URIs) for the relevant entity 410, to the ontology system 210. The ontology system 210 thereby can prepare the result 120.

The computational engine system 220, at 520, can parse the query 110. In other words, the computational engine system 220, at 520, can parse the natural language question into actionable input interpretations. Parsing the query 110, at 520, and include at least one data lookup. Additionally and/or alternatively, parsing the query 110, at 520, can include parsing the query 110 into one or more entities 410 (shown in FIG. 4A). Relevant data, such as a Company (URI) 410, thereby can be extracted, at 530, from the received structured data 310 (shown in FIG. 3) and/or unstructured data 320 (shown in FIG. 3), and calculations using the extracted relevant data can be performed.

One or more properties 420 (shown in FIG. 4A) of the relevant data can be identified, at 540. As illustrated in FIG. 5C, identifying the properties 420 of the relevant data, at 540, can include identifying up to N components. For example, FIG. 5D illustrates a first property 420, such as a Net Income (URI), at 540A, and/or identifying a second property 420, such as a Total Assets (URI), at 540B. Returning to FIG. 5C, at 550, the computational engine system 220 performs a computation of the identified properties 420. For example, as shown in FIG. 5D, a ratio between the first and second properties 420 is identified, at 520, to be used in the result 120, at 560. Advantageously, the use of the unique identifiers, or URIs, enables the computational engine system 220 to resolve any ambiguities in identifying the relevant entity 410.

As another example, the computation can include intermediate calculations that are used to provide the result 120. For the query 110 that asks “how many managers have spent 100 hours or more on all X engagements?”, the computational engine system 220 can identify all people who have worked on the X engagement and add the time of each of those engagements to yield an intermediate hours spent total for each individual. This intermediate calculation does not need to be stored and can be used only to determine the list of people to return in the result 120. Compared to traditional search engines, a custom report need not be first generated to manually achieve the result for this example query.

An alternative embodiment of the method 500 by which the computational engine system 220 (shown in FIG. 2) can generate a general result 120 is illustrated in FIG. 5E. The computational engine system 220, at 510, can receive the query 110. For purposes of illustration, the query 110 can include a question to be answered by the search system 100 (shown in FIG. 2). As shown in FIG. 5E, the result 120, at 560, can include an aggregate of different responses that the information modeling system 200 can provide. In some embodiments, the result 120 can include an answer, at 560A, a list, at 560B, and a view, at 560C. The answer can be a specific piece of information either directly pulled from the data sources 300 or calculated via the computational engine system 220 based on the received data. The list can provide a relevance ranked list of items found in the data sources 300. This feature is described with respect to the document index system 230, for example. The view can provide consolidated pieces of information pulled from the data sources 300 that apply to a selected entity 410.

As previously discussed, the result 120 can be presented in a manner consistent with the initial query 110. For example, one type of query can be looking for a specific answer (e.g., the value of one property of an entity 410) and another type of query can ask for a comparison (e.g., between two entities 410). For the specific answer (e.g., asking for a contact's phone number), the template or style sheet can include a banner with the specific answer (e.g., the phone number) and information related to that specific answer can be displayed under the banner (e.g., additional contact information). General information about the entity 410 can be shown in anticipation of the user's next request (e.g., clients, skills, and so on). Similarly, for a query asking for a comparison, the result 120 can include two columns listing relevant details for each entity 410 shown side by side.

Yet another alternative embodiment of the method 500 by which the computational engine system 220 (shown in FIG. 2) can generate a general result 120 is illustrated in FIG. 5F. The computational engine system 220, at 510, can receive the query 110. As shown in FIG. 5E, the query 110 can first undergo natural language processing, at 570, to be executed, for example, by the computational engine system 220 of the information modeling system 200. In some embodiments, the natural language processing can include a lookup, at 571, a calculation, at 572, and a visualization (e.g., providing a graph or other visual display), at 573. For example, the natural language processing parses the query 110 looking for entities 410 and their properties as well as external information. Based on the natural language parse, the lookup can include identifying a specific piece of data or a list of data from the data sources 300. This can also include identifying the type of query that is being asked. Similarly, if requested, the computational engine system 220 can perform calculations on the identified entities 410. The response from the computational engine system 220 can include a form of visualization. Additionally and/or alternatively, the computational engine system 220 can continue to look for information related, at 574, to the direct answer provided to enrich the computational engine system 220.

In some embodiments, the result 120 can be based at least in part upon relevance. The result 120, stated somewhat differently, can be presented as a result of keyword matching. In this situation, the result 120 can be similar to a result generated by a traditional search engine, except that the search system 100 advantageously can identify not only entities 410 form the keyword matching but also can traverse relationships 430 with related entities 410 to present information about entities 410 that are adjacent to the entity 410 identified based upon keyword matching alone.

If the result 120 to a selected query 110 is a specific entity 410, a unified view of information about the specific entity 410. The unified view is a collection of cards that contain information related to the specific entity 410. The contents of each card can be provided via a lookup, can be provided via a calculation, and/or can be identified via at least one sub-queries that transverses a relationship 430 between the specific entity 410 and at least one other entity 410. The unified view of a person, for example, can include contact information (provided via lookup), duration of employment (provided via calculation), and one or more companies for which the person has worked (identified via a relationship). If two entities 410 are to be compared, a unified view with specific information for the first entity 410 can be presented side-by-side with a unified view with corresponding specific information for the second entity 410.

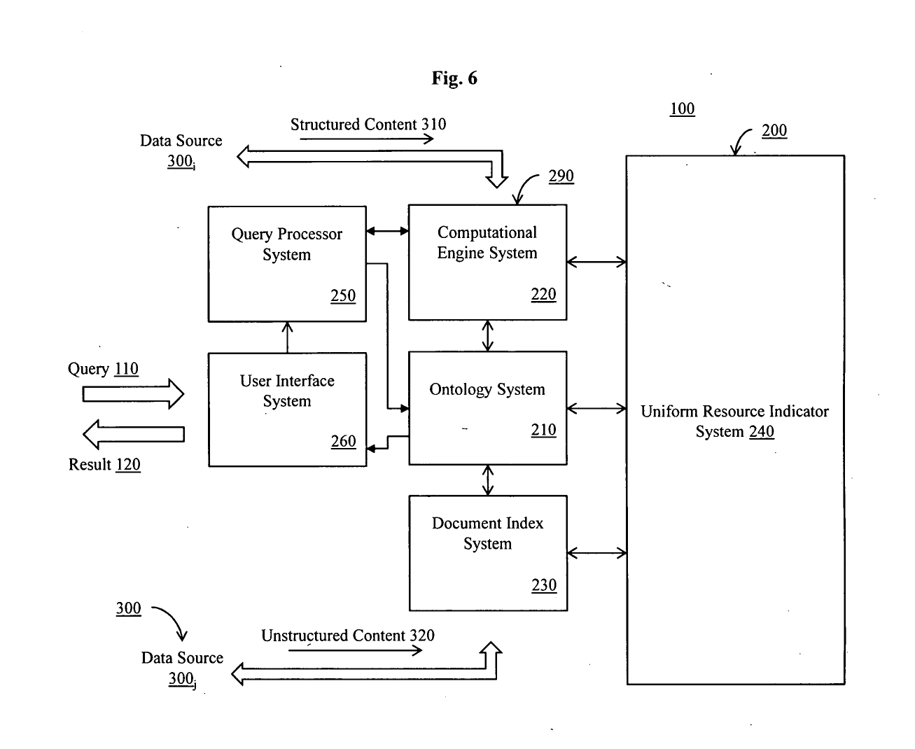

FIG. 6 illustrates an alternative embodiment of the information modeling system 200 of FIG. 3. Turning to FIG. 6, the information modeling system 200 is shown as including a user interface system 260. The user interface system 260 enables the information modeling system 200 to receive the incoming query 110, to present or otherwise provide the result 120 in response to the query 110, and navigate and/or filter through the result 120. In the manner discussed in more detail above with reference to FIG. 1A, the user interface system 260 can receive the query 110 in any conventional manner, including, for example, textually via a keyboard and/or orally via a microphone system. The user interface system 260 likewise can present the result 120 in any conventional manner, including, for example, visually via a display system and/or orally via a speaker system. In a preferred embodiment, the user interface system 260 can present the result 120 in a modular (or grouped) manner. The presentation of the result 120 thereby can be advantageously arranged (or organized) in a manner that is consistent with the query 110.

As shown in FIG. 6, the information modeling system 200 can include a query processor system 250. Although shown in FIG. 6 as being separate from the user interface system 260 for purposes of illustration only, the query processor system 250 can be at least partially integrated with the user interface system 260 and/or any other processing platforms 290 of the information modeling system 200.

The query processor system 250 can parse the query 110 and provide the parsed query to the computational engine system 220. Receiving the parsed query, the computational engine system 220 can determine whether one or more known entities 410 (shown in FIG. 4A) are included in the structured data (or content) 320. Based upon the determination, the computational engine system 220 can provide the identities of any known entity 410 that is included in the structured data 320. Additionally and/or alternatively, the computational engine system 220 can identify selected key words from the query 110 and perform keyword matching on the received data 310, 320 based upon the selected key words. The computational engine system 220, in one embodiment, can default to performing the keyword matching if no known entity 410 is identified as being included in the structured data 320. The computational engine system 220 can provide the identity of each known entity 410 that is identified during the keyword matching.

The computational engine system 220 preferably provides the identity of each known entity 410 to the ontology system 210. The ontology system 210 can search the data model 400 (shown in FIG. 4A) for any properties 420, including the URIs and other metadata, and/or any relationships 430 associated with each known entity 410. The ontology system 210 can provide the properties 420 and/or relationships 430 associated with each known entity 410 to the computational engine system 220 and/or the document index system 230. For each known entity 410 specified by the properties 420 and/or relationships 430, the computational engine system 220 and/or the document index system 230 can utilize the properties 420 and/or relationships 430 to locate any documents and/or other data 310, 320 that is available from the data source(s) 300 and that is related to the known entity 410.

The information modeling system 200 can utilize the documents and/or other data 310, 320 that are available from the data source(s) 300 and that are related to each known entity 410 to generate the result 120 to the query 110. The result 120 thereby can include an explicit answer, such as looked-up data 310, 320 and/or computations based upon the looked-up data 310, 320, to the query 110. Additionally and/or alternatively, the result 120 can include at least one entity 410, such as one or more organizations and/or individuals, and/or at least one property 420 of the entity 410, such as a skill possessed by a selected individual. The result 120, additionally and/or alternatively, can include one or more documents and/or other data 310, 320 that are related to the entity 410 and/or the property 420 of the entity 410.

Thereby, use of the properties 420 and/or relationships 430 associated with each known entity 410 advantageously enables the information modeling system 200 to perform transformations on the received data 310, 320 based upon each entity 410 associated with the query 110. In other words, the information modeling system 200 advantageously can identify a specific entity 410 associated with the query 110 and can match the specific entity 410 with specific data 310, 320 (and/or perform calculations on the data 310, 320 based upon the properties 420 and/or relationships 430 associated with the specific entity 410).

The information modeling system 200 can receive the data 310, 320 from the data source(s) 300 in any suitable manner. For example, although the information modeling system 200 can search the data source 300 for the data 310, 320 upon receiving the query 110, the information modeling system 200 preferably searches the data source(s) 300 prior to receiving the query 110. The information modeling system 200, for example, can search the data source(s) 300 at predetermined time intervals, which can comprise uniform time intervals and/or non-uniform time intervals, and/or up determining that new (or updated) data 310, 320 has been added to the data source(s) 300.

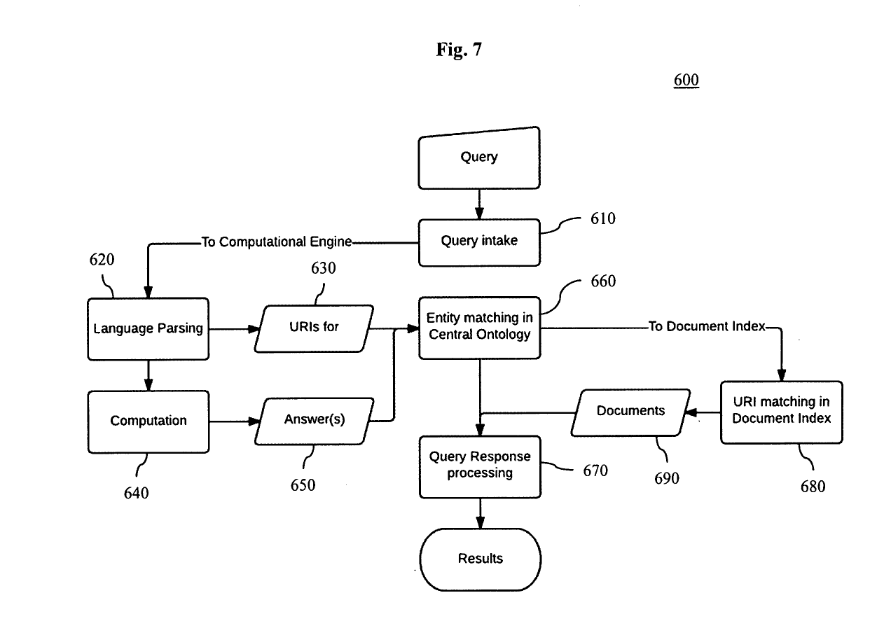

FIG. 7 shows an exemplary method 600 by which the information modeling system 200 of FIG. 6 can compute a result 120 from an incoming query 110. Advantageously, the method 600 includes an ability to compute the result 120 even if the result 120 does not exist directly in the received structured data (or content) 310 and/or unstructured data (or content) 320 (collectively shown in FIG. 3). In other words, the computational engine system 220 (shown in FIG. 6) can perform one or more operations on the received data 310, 320, as needed, to determine the result 120. The method 600 includes parsing the query 110 to identify individual query components. Known entities 410 (shown in FIG. 4A) that are known and related to the query components are identified, and the identifiers, such as the URIs, are used to perform any lookups, calculations, and/or relationship traversals in the received data 310, 320 to assemble the result (or response) 120 to the query 110.

The result 120 can be provided to the user interface system 260 (shown in FIG. 6) for presentation. In one embodiment, the user interface system 260 can use cards (not shown) to present individual results 120 into a larger view. Each card can comprise a group (or container) of related information that can be displayed on a page of the user interface system 260. For example, a card can include a collection of contract details for a selected individual. Advantageously, the result 120 can be presented with a modular construction. The result, in other words, can be presented as a view that includes a collection of one or more cards that are assembled to create a comprehensive page about the relevant entity 410. The cards can be selected and/or arranged in the order by which the cards are to be rendered on the page. In some examples, the rendering includes ordering the cards as well as determining whether the results 120 include a card or a link to additional data. Furthermore, if the results 120 do not include an answer or have more extensive information than anticipated, the card can be left out completely or given more attention, respectively.

As illustrated in FIG. 7, the query 110 can be received, at 610. The received query 110 can be provided to the computational engine system 220. As desired, the received query 110 can be provided to the computational engine system 220 either directly and/or indirectly via, for example, one or more processing platforms 290, such as the ontology system 210. In some embodiments, the computational engine system 200 can initially identify a type from the received query 110 (e.g., comparison versus looking for an answer). Upon receiving the query 11, the computational engine system 220 can parse, at 620, the language of the received query 110 and can identify any unique identifiers, or URIs, for the parsed query language. In other words, the computational engine system 220 can pull the received query 110 apart to generate an input interpretation for searching understood (or defined) knowledge domains. As needed, the computational engine system 220 can perform computations, at 640, on the received query 110 in an attempt to provide answers, at 650, to the query 110.

The input interpretation, including any answers and/or associated unique identifiers such as URIs, can be provided to the ontology system 210. The ontology system 210 can use the input interpretation and other information provided by the computational engine system 220 to search for, and/or identify, any entity 410 and/or properties 420 in the data model 400 that may be relevant to the query 110. The ontology system 210, for example, can match the unique identifiers and/or answers with one or more entities 410 that are known to the information modeling system 200 and that are relevant to the unique identifiers and/or answers. Information about the relevant, known entities 410 can be further processed, at 670, to provide the result 120 to the query 110. For example, the ontology system 210 can traverse the relationships 430 between the known entities 410 in an effort to identify any entity 410 that has a relationship 430 with the entities 410 identified by the computational engine system 220. If the ontology system 210 identifies an entity 410 with a relationship 430 with the entities 410 identified by the computational engine system 220, information about that entity 410 can be included in the result 120.

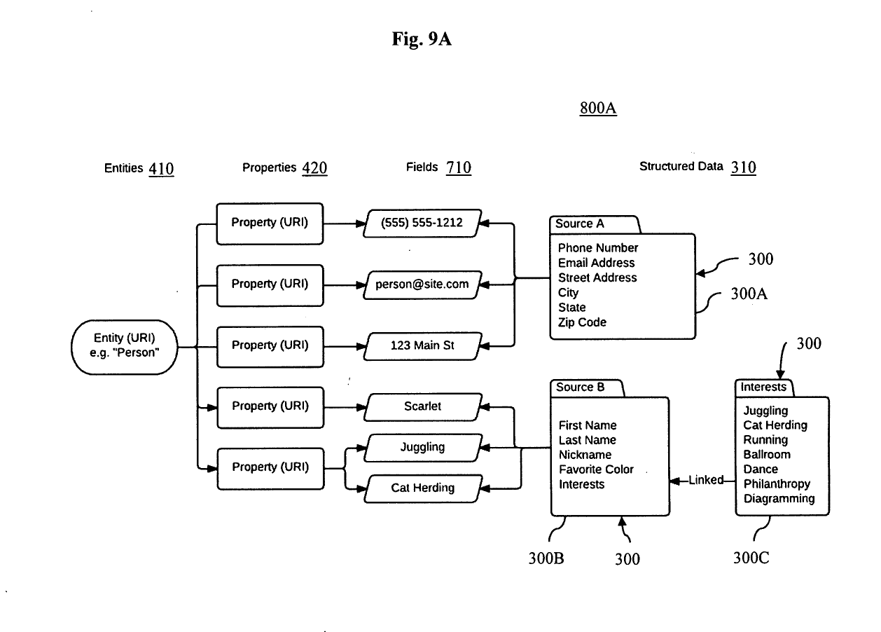

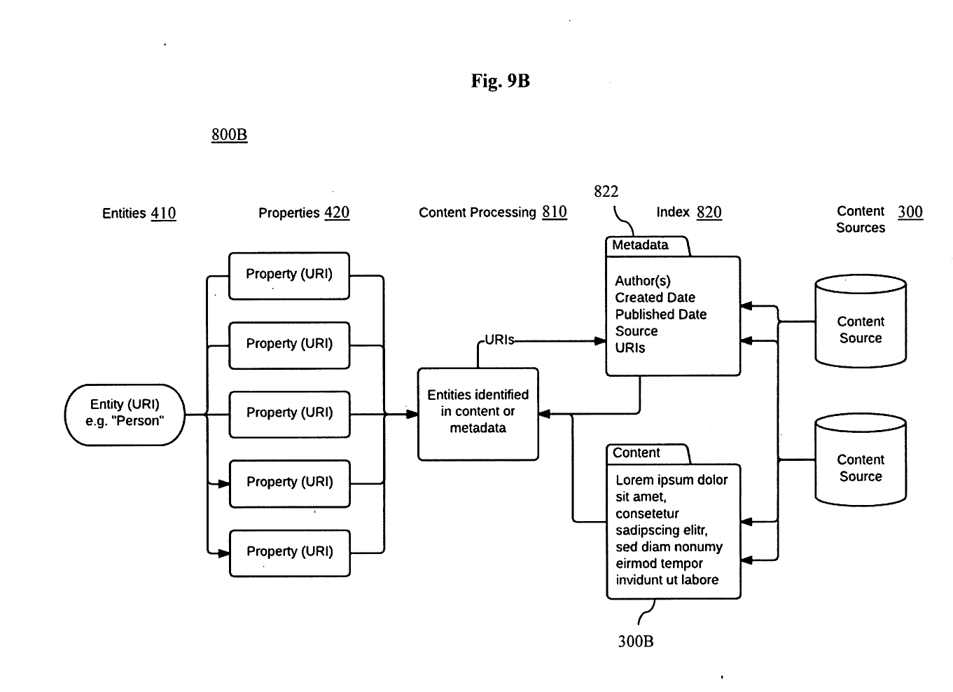

As needed, the ontology system 210 can utilize the unique identifiers, such as the URIs, from a selected entity 410 that was identified above to look for data and other content in the document index 820 (shown in FIG. 9B) that is related to the selected entity 410. The ontology system 210, for example, can attempt to identify content in the document index 820 that was authored by the selected entity 410 and/or mentions the selected entity 410. The ontology system 210 can provide the information about the relevant, known entities 410 to the document index system 230. The document index system 230 can compare the unique identifiers with the received unstructured data 320, at 680, attempting to identify any received unstructured data 320 that matches the relevant, known entities 410. The document index system 230 thereby can provide, at 690, any documents or other materials available among the received unstructured data 320 that relates to the relevant, known entities 410. The documents or other materials can be further processed, at 670, with the information about the relevant, known entities 410 to provide the result 120 to the query 110.

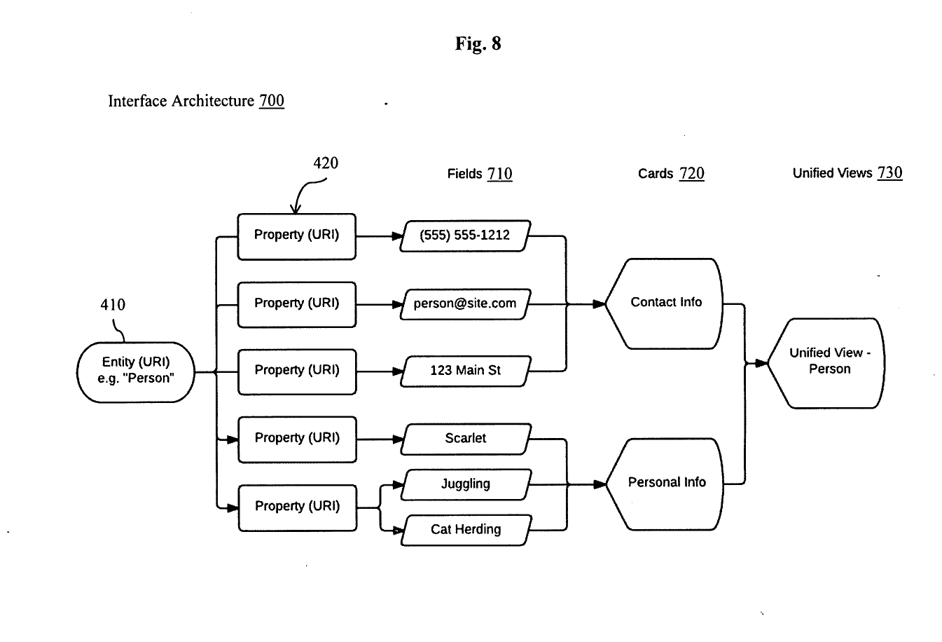

In the manner set forth above, the result 120 in response to the query 110 can be presented in any conventional manner. The user interface system 260 of the information modeling system 200, for example, can include an interface structure for presenting the result 120. An exemplary interface structure 700 for the user interface system 260 is shown in FIG. 8.

The result 120 can include information derived from the received structured data 310 and/or the received unstructured data 320 (collectively shown in FIG. 3). The structured data 310 and/or the metadata about the unstructured data 310 can include specific attributes about an entity 410 and/or document. If the relevant entity 410 comprises a person, the specific attributes about the person can include a telephone number and/or an electronic mail (or email) address of the person. These attributes can be associated with the user interface system 260 through a custom code and, when appropriate, can be presented.

As illustrated in FIG. 8, a selected entity 410 can be associated with one or more properties 420 in the manner discussed in more detail above with reference to FIG. 4A. Each of the properties 420 of FIG. 8 are shown as being associated with one or more fields 710. Exemplary fields 710 can include a telephone number, an electronic mail (or email) address, a physical (and/or mailing) address, preferences, interests, personal information and/or other attributes associated with the entity 410.

The fields 710 can be assembled into one or more logical groupings (or cards) 720. Use of the cards 720 enables the fields 710 to be provided as reusable interface components for displaying one or more collections of the fields 710 that make sense together. Exemplary cards 720 can include contact information and personal information. As shown in FIG. 8, the telephone number, electronic mail (or email) address, and physical (and/or mailing) address of the entity 410 can be associated with a contact information card 720 of the entity 410; whereas, the preferences, interests, and other personal information of the entity 410 can be associated with a personal information card 720 of the entity 410.

The collection of cards 720 for the entity 410 can form at least one unified view 730 for the entity 410. The unified view 730 can be an assembly of cards 720 for creating a coherent presentation of information about the entity 410. The presented information can include information specific to a person or company and/or more general information from the results 120 of a search.

In one embodiment, a selected card 720 associated with the entity 410 can be conditionally presented within the unified view 730 based, for example, on the relevance and/or applicability of the selected card 730 within a context of the unified view 730. Operation of this embodiment of the information modeling system 200 can be illustrated via several example cases. The first example involves a query 110 for identifying a selected entity 410 for whom insufficient information is available to complete a card for the select entity 410. For instance, the selected entity 410 might not be associated with any known engagements. For such a case, a card for the selected entity 410 is not included in the unified view 730.

In a second example, the query 110 can request a specific property of a selected entity 410, such as a telephone number for a selected individual who is known to the information modeling system 200. Since the selected individual is known to the information modeling system 200, the information modeling system 200 can recognize, and build a digital persona for, the selected individual. The information modeling system 200 thereby can include the telephone number with the card associated with the selected individual. The telephone number of the selected individual, for instance, can be included as an “answer” card for the selected individual. The “answer” card with the telephone number of the selected individual can be presented within a predetermined region of the unified view 730. The predetermined region of the unified view 730 can comprise any predetermined region of the unified view 730, such as a top region, a bottom region and/or a side region of the unified view 730.

Alternatively, the query 110 can involve a request for a preselected property 420, such as net income 540A or total assets 540B, of a selected company, in the manner set forth above with reference to FIG. 5B. If the selected company is known to the information modeling system 200, the information modeling system 200 can include the preselected property 420 with an “answer” card associated with the selected company and can present the “answer” card within the predetermined region of the unified view 730 in the manner set forth in the immediately-preceding example.

Advantageously, the unified view 730 can present the results 120 to an inquiry 110 and/or any returned page. In one embodiment, the information modeling system 200 can provide a default (or standard) manner for presenting the result 120 and/or the returned page. The information modeling system 200, in other words, can provide a default (or standard) unified view 730 for the entities 410. The default unified view 730 can be uniform for all of the entities 410 and/or can comprise a different unified view 730 for entities 410 with one or more selected properties 420. Each returned page can be associated with rules for assembling the cards for presentation. For business-related entities 410, for example, the default unified view 730 can present a financial metric card, a business overview card, a business contacts card, and/or one or more answer cards. The default unified view 730 can be at least partially user-adjustable, and preferably fully user-adjustable, such that the unified view 730 can be customized in accordance with a user-defined preference. In other words, the cards included in the unified view 730 can be arranged in any suitable manner by a user. Additionally and/or alternatively, one or more cards can be added to, and/or removed from, the unified view 730 such that the unified view 730 is fully customizable. In one example, the unified view 730 can include a subset of the one or more cards in an initial view and further include an option to view more cards. Advantageously, for queries that may return several results (e.g., “All contacts at Company X”), the unified view 730 can include, for example, ten contact cards—prioritized as discussed above—and a link to more cards at the bottom of the view.

As discussed above with reference to FIGS. 1A-B, the information modeling system 200 can receive structured data (or content) 310 and/or unstructured data (or content) 320 from one or more data sources 300. The structured data 310 can be ingested via the ontology system 210 in the manner illustrated in FIG. 9A. Turning to FIG. 9A, a selected entity 410 can be associated with one or more properties 420 in the manner discussed in more detail above with reference to FIG. 4A. Each of the properties 420 of FIG. 9A can be associated with one or more fields 710 in the manner discussed in more detail above with reference to FIG. 8.

Each field 710 can be assigned to a unique identifier, such as a URI, for identifying a type of data or other information that is stored in the field 710. The data or other information that is stored in the field 710 can be received from a relevant data source 300. As shown in FIG. 9A, a first data source 300A can provide contact information for the selected entity 410; whereas, a second data source 300B can provide personal information for the selected entity 410.

Two or more of the data sources 300 advantageously can be linked to enhance the amount and quality of the structured data 310 available to the information modeling system 200. The second data source 300B of FIG. 9A, for example, is illustrated as communicating with a third data source 300C that can provide interest information for the selected entity 410 to the second data source 300B. The personal information for the selected entity 410 that is available from the second data source 300B thereby can be enhanced to include the interest information for the selected entity 410 that is available from the third data source 300C. Although shown and described as providing the interest information for the selected entity 410 to the information modeling system 200 indirectly via the second data source 300B for purposes of illustration only, the third data source 300C can directly provide the interest information for the selected entity 410 to the information modeling system 200.

The information that is stored in the field 710 along with the assigned unique identifier can be shared with one or more other processing platforms 290, such as the computational engine system 220, of the information modeling system 200. Sharing the information that is stored in the field 710 along with the assigned unique identifier helps to ensure that the ontology system 210 and the other processing platforms 290 refer to the same type of information when the query 110 (shown in FIG. 6) is received.

Additionally and/or alternatively, the information modeling system 200 can receive unstructured data (or content) 320 from one or more data sources 300 in the manner discussed above with reference to FIGS. 1A-B. The unstructured data 320 can be ingested via the document index system 230 in the manner illustrated in FIG. 9B. As discussed above with reference to FIG. 3, the document index system 230 can uses a crawling process for identifying unstructured data 320. Although shown and described as receiving the unstructured data 320 from two data sources 300 with independent data paths for purposes of illustration only, at least one data source 300 can indirectly provide the unstructured data 320 to the information modeling system 200 via one or more intermediate data sources 300.

Turning to FIG. 9B, a selected entity 410 can be associated with one or more properties 420 in the manner discussed in more detail above with reference to FIG. 4A. As the unstructured data 320 is indexed by the document index system 230, the unstructured data 320 can be provided to the ontology system 210. The ontology system 210 can perform content processing 810 on the unstructured data 320. The content processing 810 can identify any known entity 420 that is referenced in the unstructured data 320. In other words, the ontology system 210 can identify any structured data 310 that is referenced in the content or associated metadata of the unstructured data 320. The ontology system 210 thereby can provide one or more unique identifiers, such as URIs, for the referenced structured data 310 to the document index system 230.

The document index system 230 can generate an index 820 as illustrated in FIG. 9B. The index 820 can include metadata 822 for any structured data 310 that is referenced in the content or associated metadata of the unstructured data 320 and/or an index 824 of the unstructured content 320. By sharing the unique identifiers for the referenced structured data 310 with the document index system 230, the ontology system 210 and the document index system 230 each can advantageously reference related structured and unstructured data 310, 320 when the query 110 (shown in FIG. 6) is received.

If a query 110 comprises a name of an individual, for example, the query 110 can be provided to the document index system 230. The query 110 advantageously can be provided to the document index system 230 as a text string and/or with a unique identifier for associating the text string with an entity 410. As the document index system 230 can gather documents in response to the query 110, one or more of the gathered documents can be selected based upon the unique identifier. In other words, the document index system 230 can gather and selected the documents based upon the text string and/or the unique identifier. The document index system 230 thereby knows the named individual and can sort the gathered documents. Based upon the nature of the query 110, the document index system 230 can apply preferences when sorting the documents. The document index system 230 thereby can distinguish between gathered documents authored by the named individual and documents that mention the named individual. In some embodiments, the document index system 230 can indicate whether the documents match a URI and can provide results related to the matched URI.

Turning to FIG. 10B, an exemplary detail diagram illustrating an alternative embodiment of the information modeling system 200 that can be used with the diagram of FIG. 10A is shown. The information modeling system 200 shown in FIG. 10B further includes a data preparation system 251 and a connector system 252. The data preparation system 251 is a processing platform 290 that can include a data model for converting the received structured data (or content) 310 (shown in FIG. 3) into a form ingestible by the ontology system 210 and the document index system 230. Similarly, the connector system 251 is a processing platform 290 that can include a data model for translating between the received unstructured data (or content) 320 (shown in FIG. 3) and the document index system 230. The information modeling system 200 of FIG. 10B includes an authentication system 270 for controlling access to the user interface system 260.

Although shown in FIG. 10B as being separate from the user interface system 260 for purposes of illustration only, the authentication system 270 can be at least partially integrated with the user interface system 260 and/or any other processing platforms 290 of the information modeling system 200. Similarly, the data preparation system 251 and the connector system 252 can be at least partially integrated with any other processing platforms 290 of the information modeling system 200.

FIG. 10C shows an exemplary method 850 by which the information modeling system 200 of FIG. 10B can begin to receive an incoming query 110. After the user wishes to launch a search and a launch search entry is submitted, the user information can be passed through a proxy server, at 851. An enterprise directory can be used to provide authentication and identify information for the user based via the authentication system 270, at 852. Once authenticated, the user can begin interacting, at 853, with the user interface system 260.

Accordingly, the search system 100 disclosed herein provides numerous advantages for enhancing data searches. The search system 100 enables key entities in the domain to be extracted and uniquely identifying. The resulting identifiers can be distributed as metadata across a number of separate indexing platforms. Each platform is capable of performing a different process on the data to be searched and of returning specific result type. The identifiers can be developed during indexing and used to augment the incoming query as the entities are parsed. In addition, the result 120 from the multiple search platforms of the search system 100 can be dynamically presented via modular views made from component cards. The multiple views advantageously can be constructed for different domain areas by combining different cards in combination. Furthermore, the multiple search platforms of the search system 100 can focus on structured and/or unstructured data as well as private (organizational) data and publicly available knowledge. Information and identifiers regarding entities extracted from the structured data thereby can be applied for enhancing the metadata present in the unstructured data and to unify private and public data.

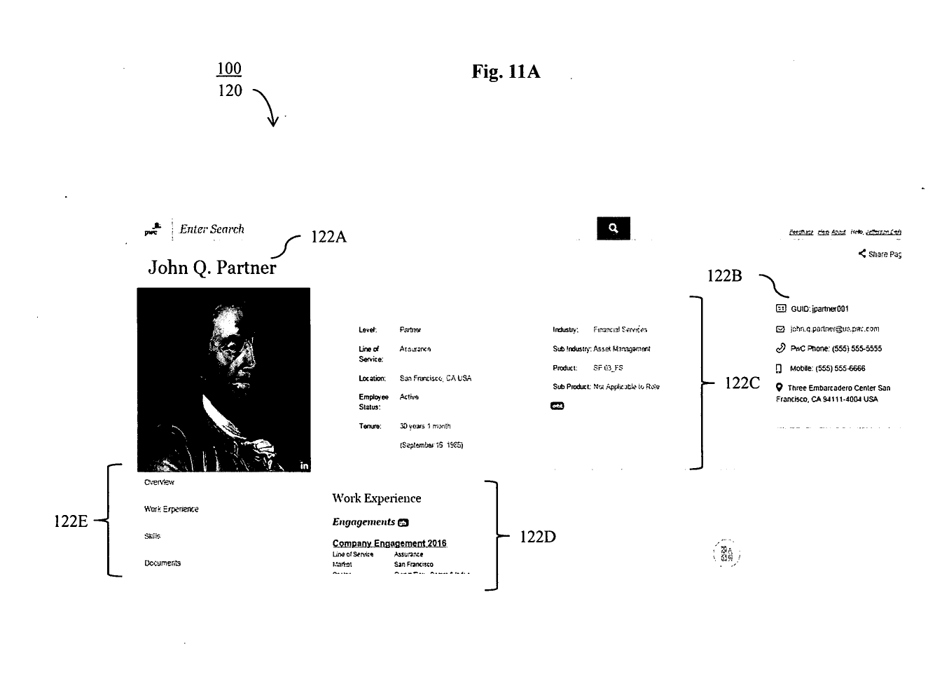

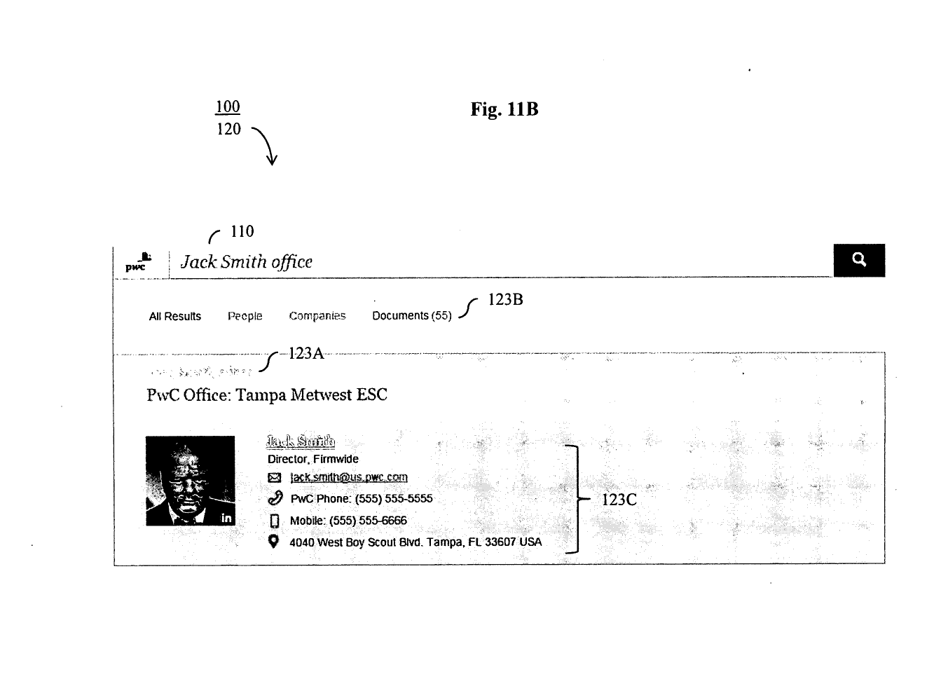

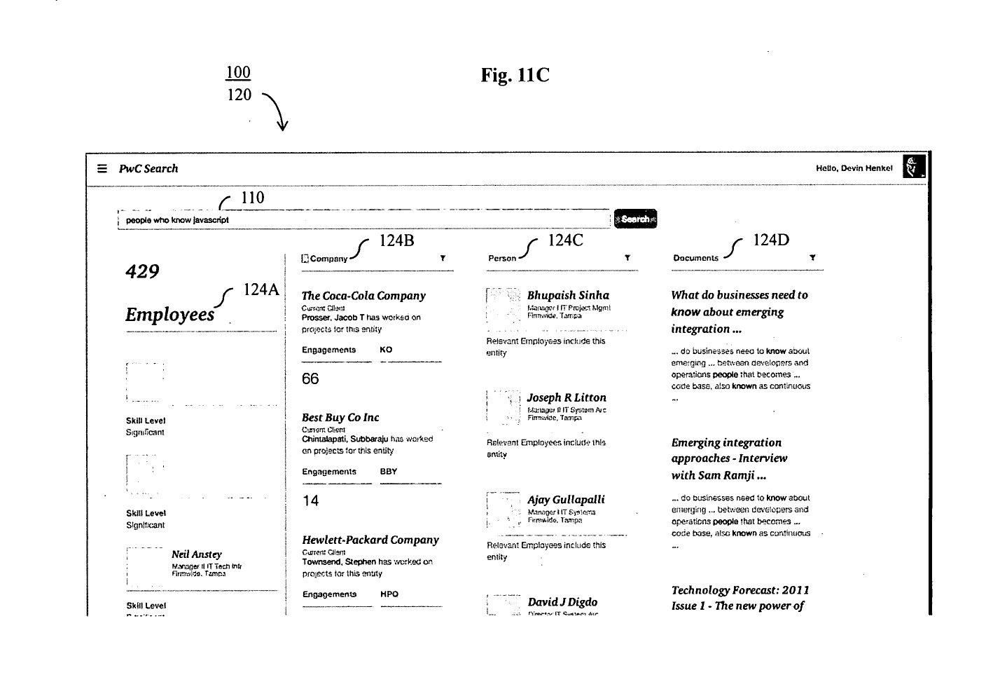

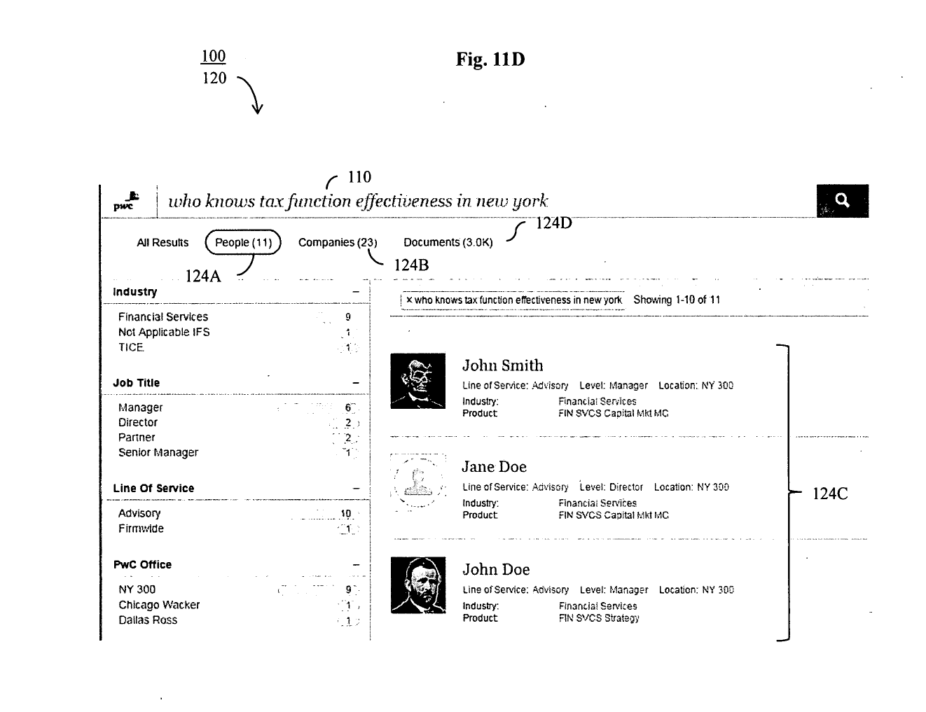

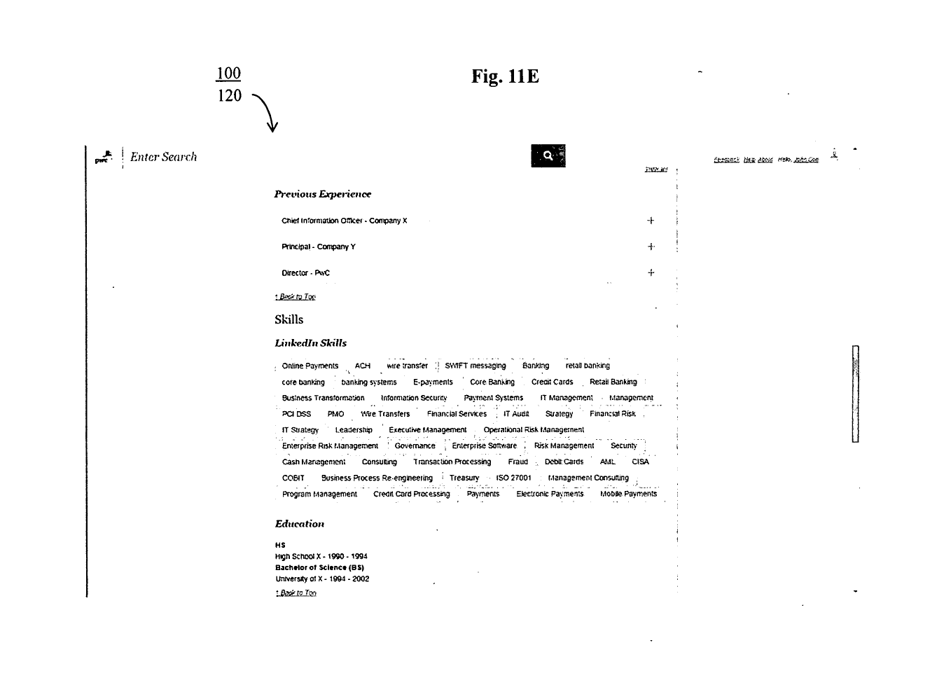

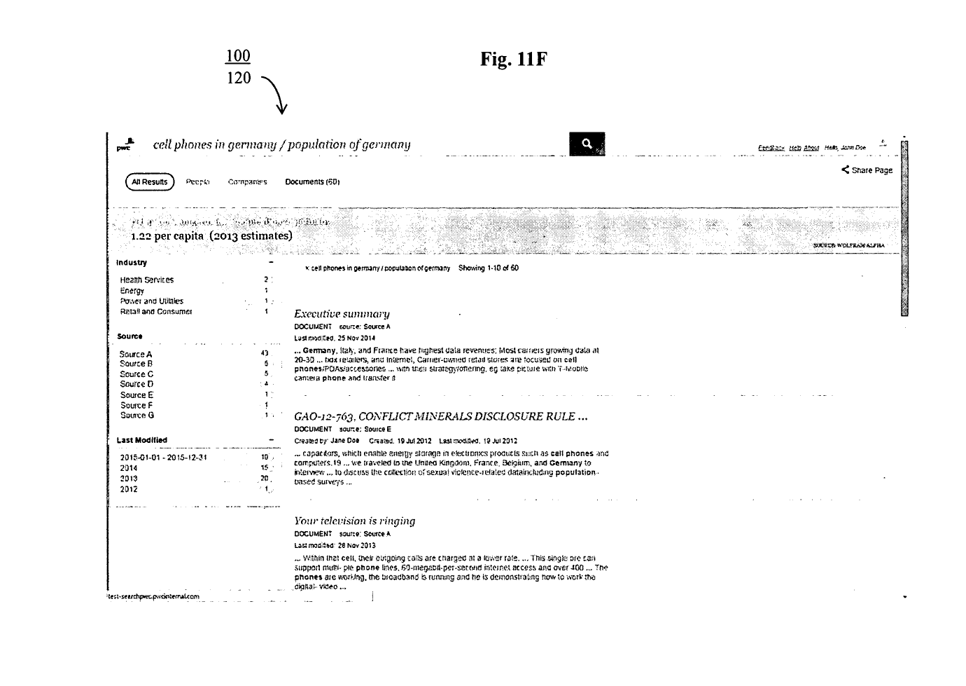

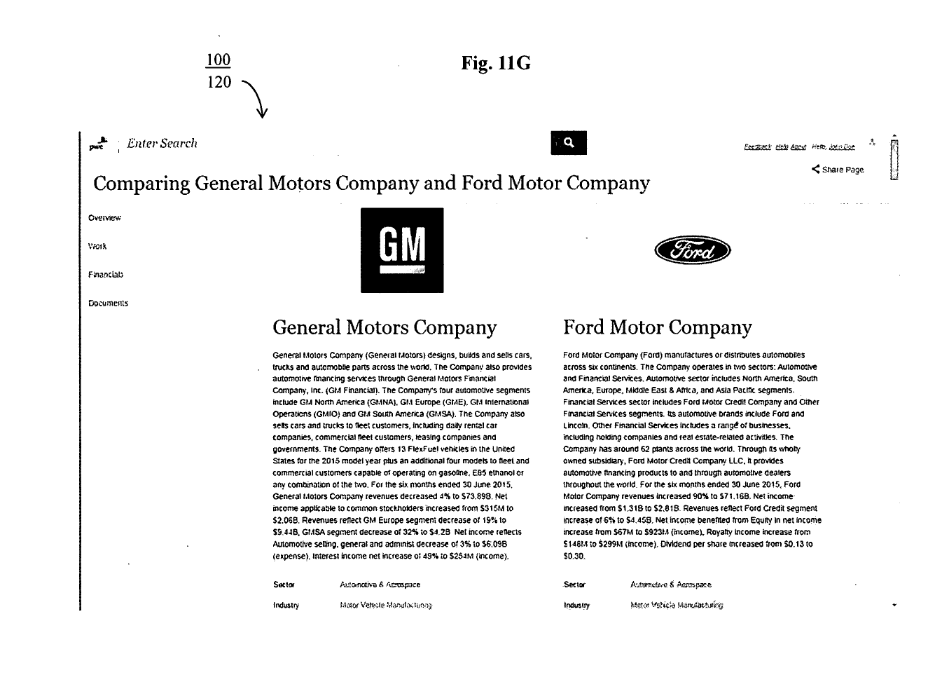

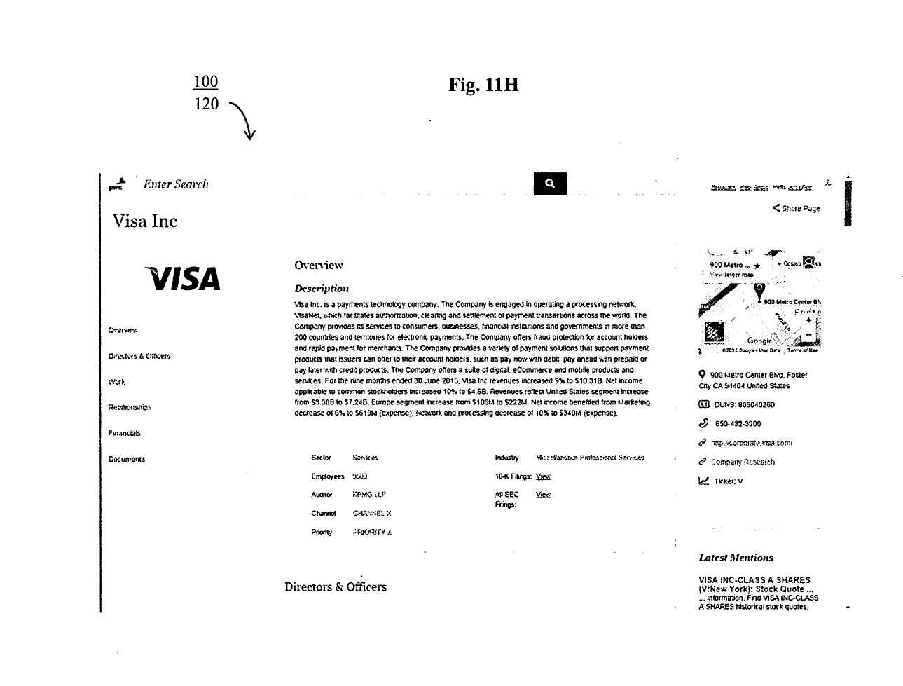

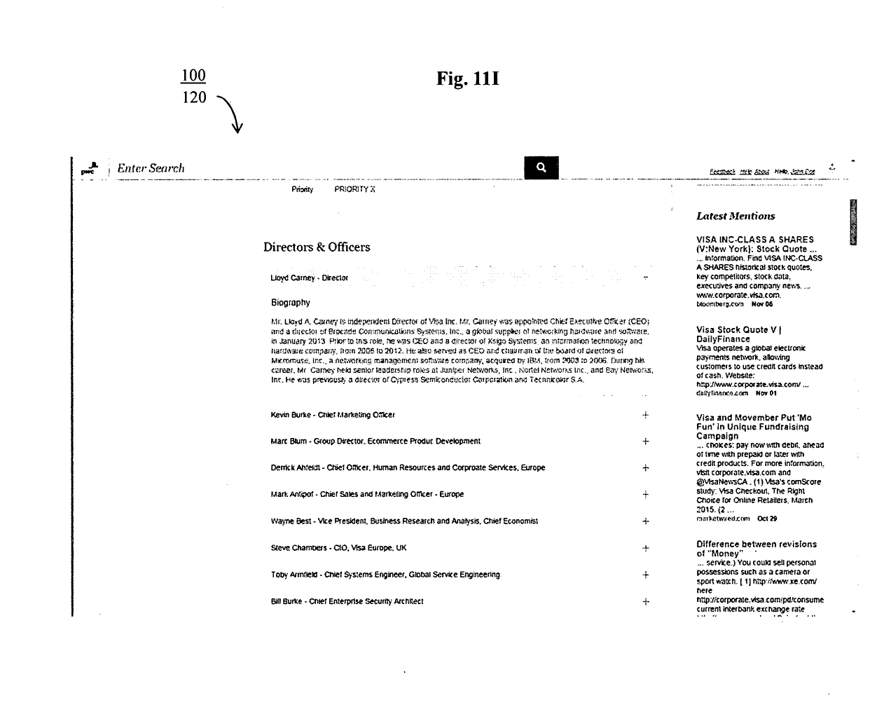

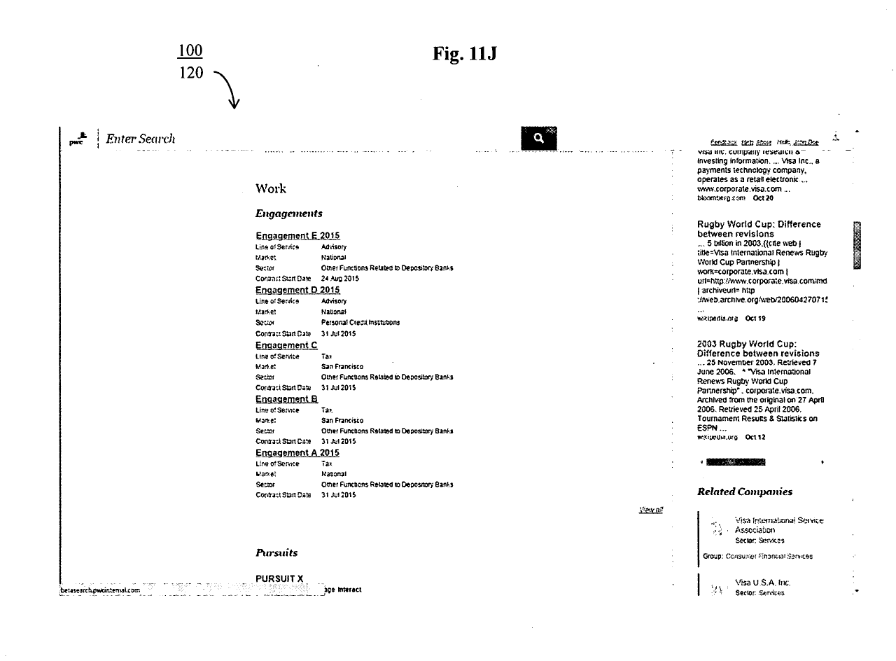

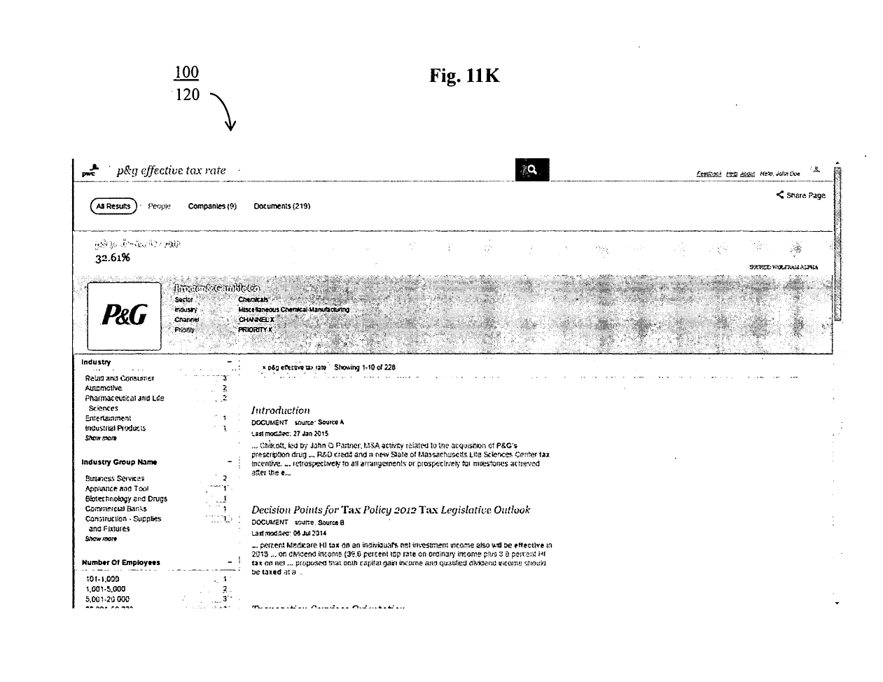

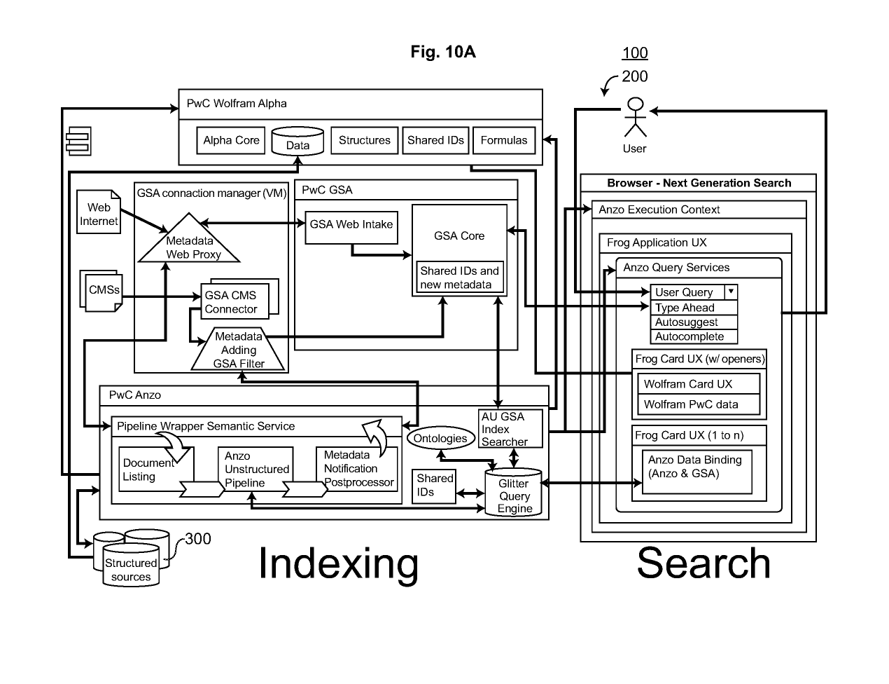

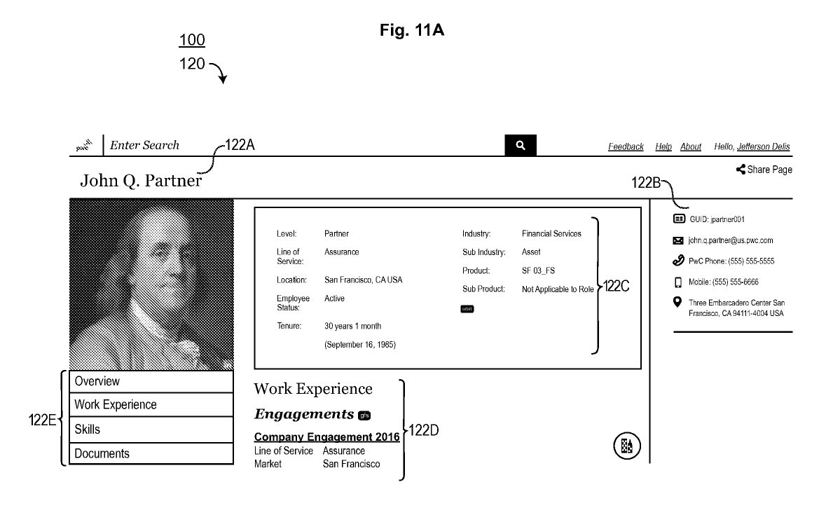

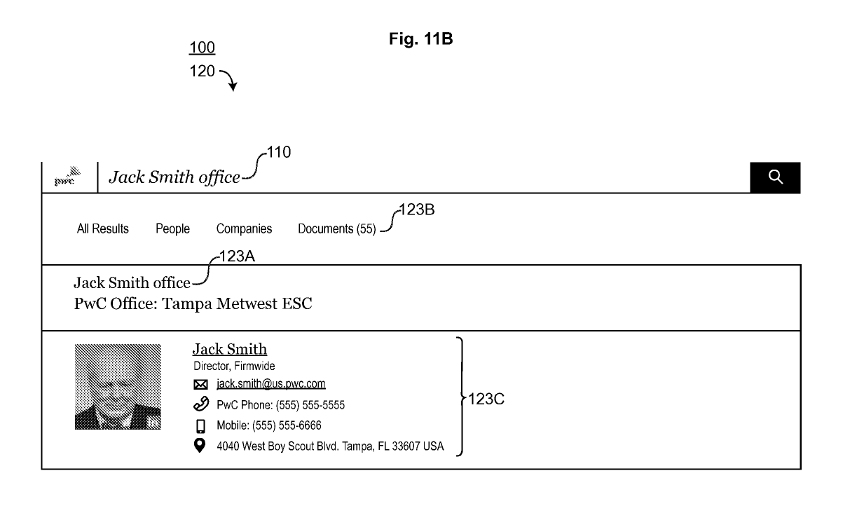

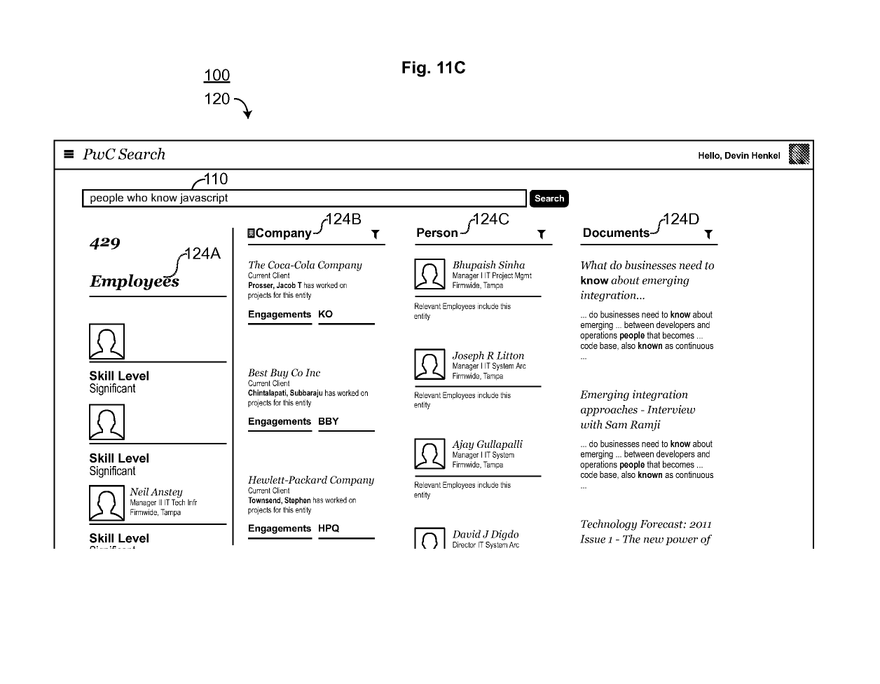

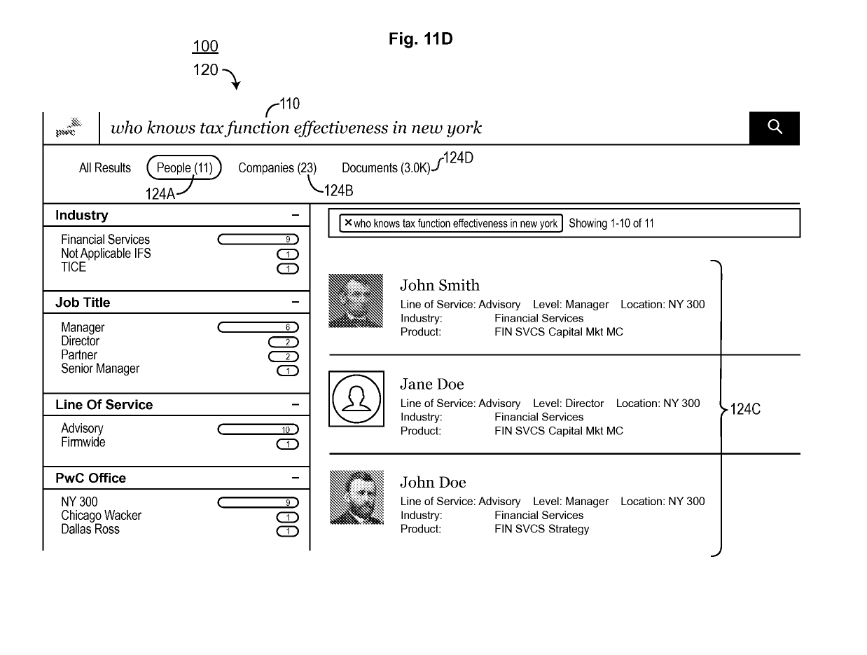

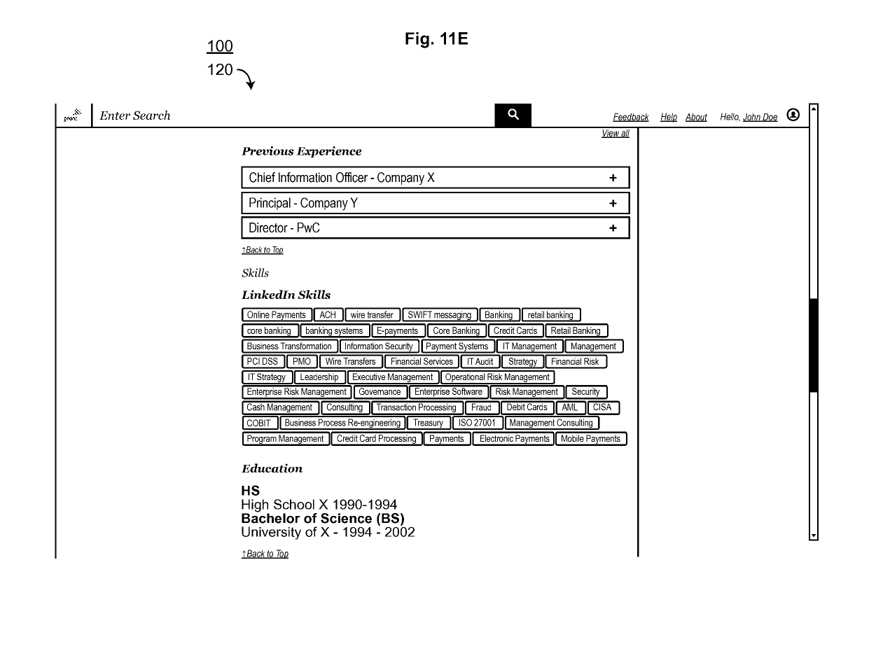

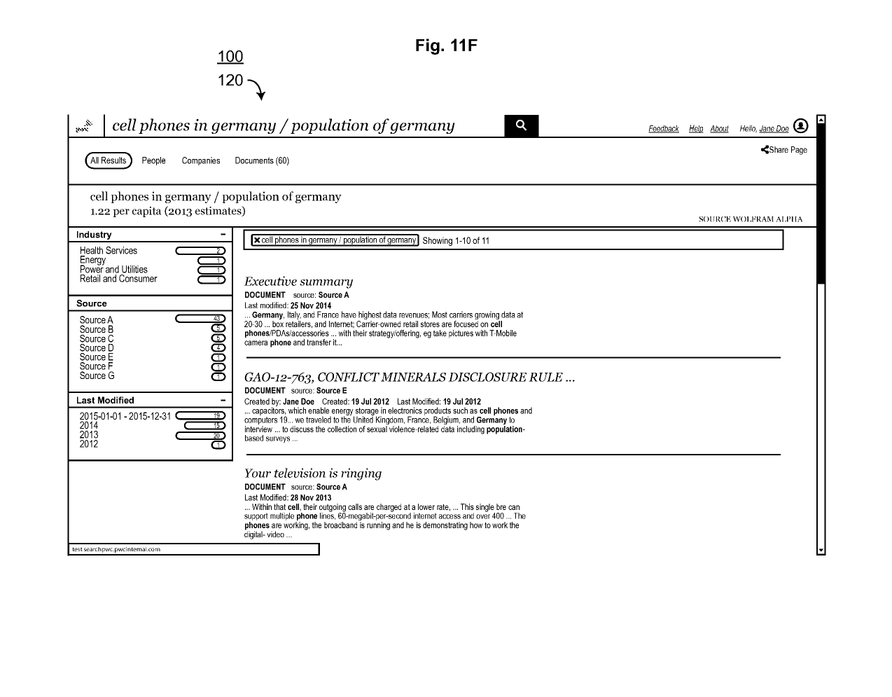

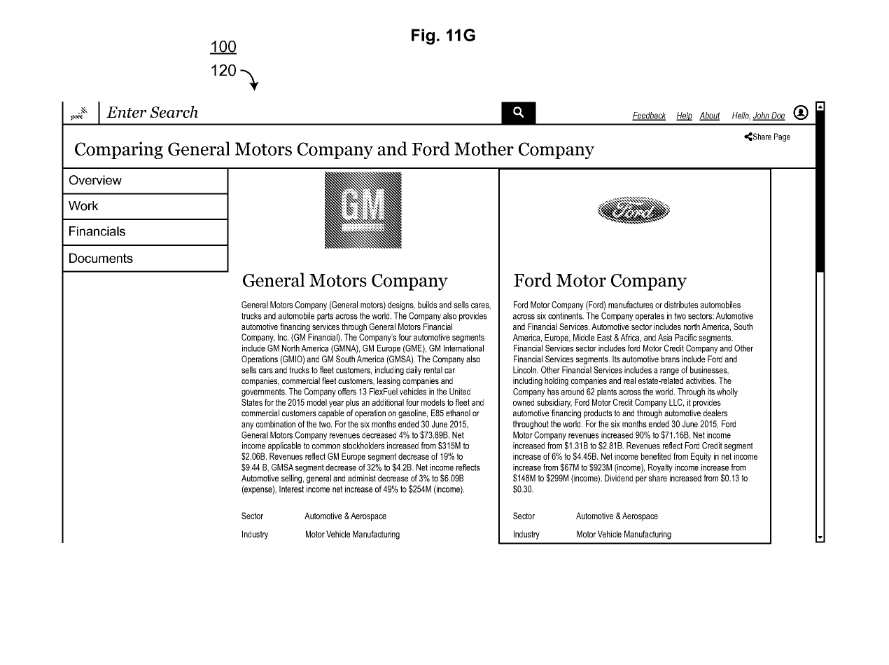

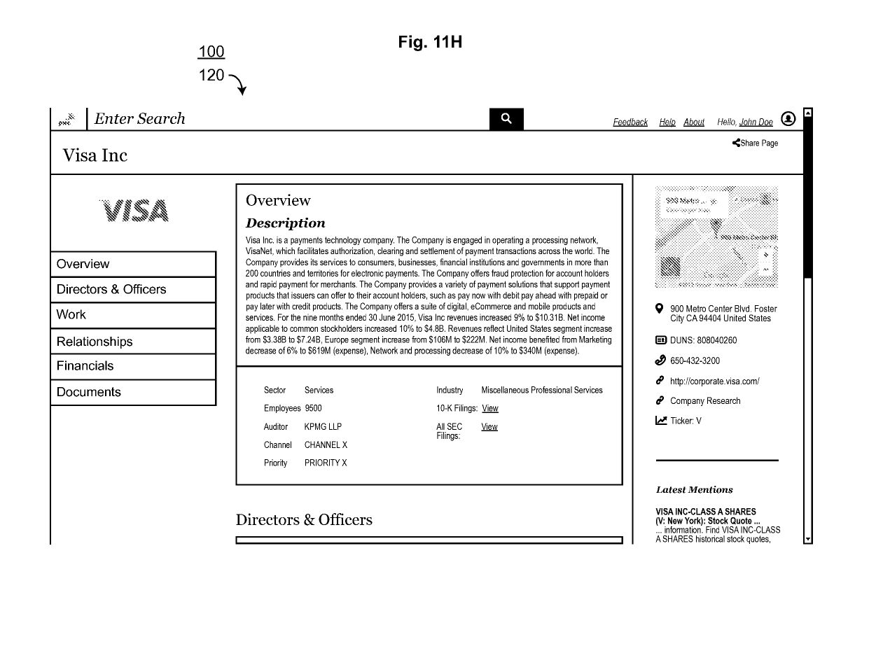

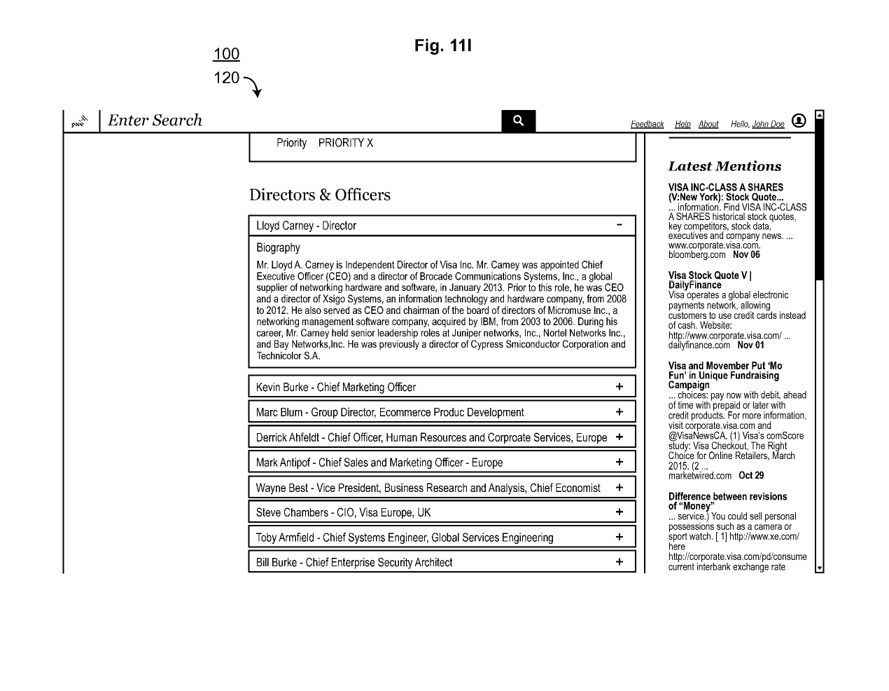

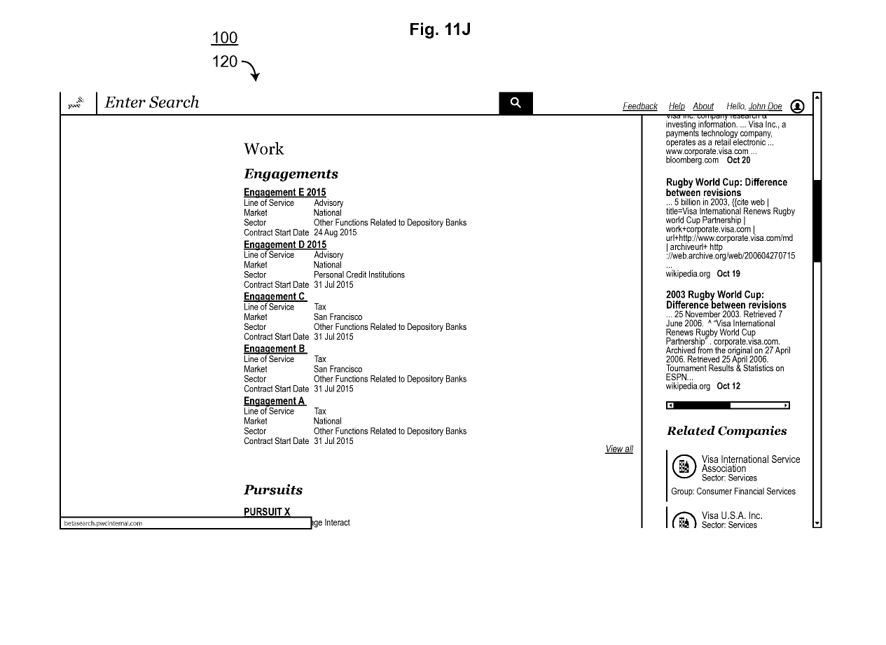

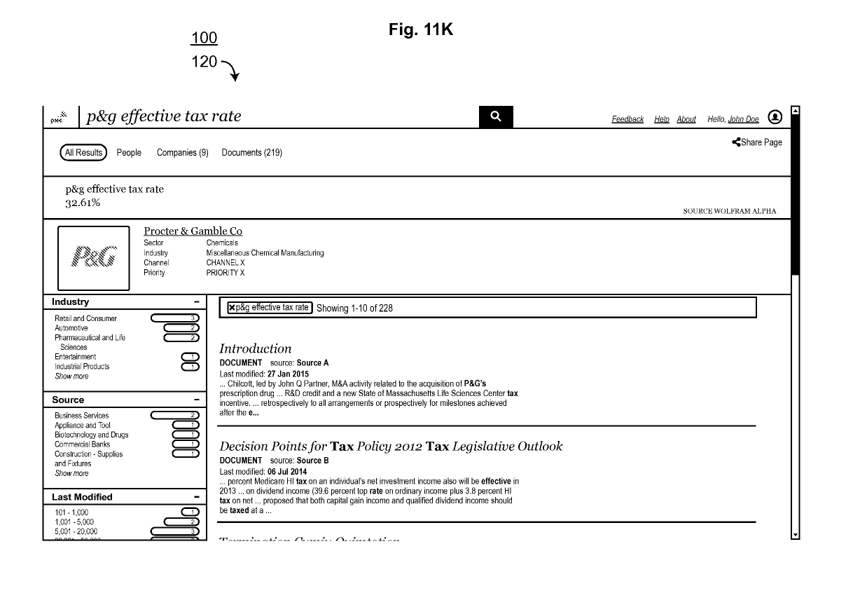

In the manner set forth above, the result likewise can be presented in any conventional manner. FIG. 11A illustrates an embodiment of a result 120 to a specific query 110 about an identified entity 410, here a person. As shown in FIG. 11A, the result 120 can be presented unified view of the identified person by combining disparate types of content about the identified person from the internal and/or external data sources 300. The content can be aggregated to provide one or more specific data views about the identified person. Data from a selected data source 300, for example, can be seamlessly integrated into one or more containers, or cards, which are, in turn, assembled into a view. Each card includes a small, but conceptually related, set of data from a selected data source 300 and/or having a predetermined data format. The data set for each card can include data from one or more data sources 300 and/or having the same, or different, data formats. Each card can be linked to a code for determining how the card will be presented.

For example, a view of the identified person can contain a first card for the person's location information, a second card for the person's skill information, a third card for the person's project information without limitation. The view can include any suitable number of cards each having information about a preselected attribute for the identified person. The cards can be combined in any manner, order and/or arrangement to provide an overall contextual view of the identified person.

The result 120 as shown in FIG. 11A includes name information 122A and/or contact information 122B for the identified person. As desired, the results for the identified person likewise can include biographical information 122C. FIG. 11A also shows that the result 120 can include a matrix 122D of employment information. Exemplary employment information can include, but is not limited to, staff level information, live of service information, location information, employment status information, industry information, sub-industry information, tenure information, product information and/or sub-product information as illustrated in FIG. 11A. Additionally and/or alternatively, the result 120 for the identified person advantageously can be divided into two or more views 122E for facilitating navigation of the result 120. As shown in FIG. 11A, for example, the views 122E can include overview information, contact information, work experience information, skills information, credentials information, and/or documentary information, without limitation.

In another embodiment, the information modeling system 200 can provide the result 120 as a smart result. The smart result is a direct response to a particular query 110 and includes results within specific domains, such as within companies, among people, and within documents. The smart result can include one or more specific answers to the query 110 and/or answers that fulfill the spirit of the query 110.

Turning to FIG. 11B, for example, the smart result is shown as a contact card and is illustrated as a direct response to the particular query 110 (i.e., Jack Smith office). The result 120 as shown in FIG. 11B includes name information 123A and/or contact information 123C for the identified person. There are also links to documents 123B for documents that are authored by and/or related to the identified person as discussed above.

In another example, with reference to FIG. 11C, the query 110 requests information about people who meet a certain criteria, here people who know javascript. The result 120 includes a presentation of individuals 124A who meet the certain criteria. Additionally and/or alternatively, the result can include other information about the individuals 124A. As show in FIG. 11C, for example, the result can include one or more companies 124B for whom a relevant individual has worked, supervisors 124C for whom a relevant individual has worked, and/or documents 124D that are related to the query 110 and/or are authored by the individuals implicated by the query 110, without limitation. As desired, the result 110 can include links to access further information about one or more of the individuals 124A, companies 124B, supervisors 124C and/or documents 124D. FIG. 11D illustrates an alternative view of a similar result 120 that is shown in FIG. 11C. Additional examples of the result 120 are shown in FIGS. 11E-K

For example, FIG. 11E shows skills of an identified person from social media sites (e.g., LinkedIn®). FIG. 11F illustrates computational results based on the query 110 requesting a ratio of one entity 410 (e.g., cell phones) to a second entity 410 (e.g., a population). FIG. 11G illustrates that comparisons between entities 410 (shown here as companies) dynamically can be presented in an alternative user interface based on the query 110. FIGS. 11H and 11I show the result 120 when data is pulled from an external data source (e.g., the data source 300). FIG. 11J illustrates the result 120 that incorporates internal data in the same result 120 shown in FIGS. 11H and 11I.

The disclosed embodiments are susceptible to various modifications and alternative forms, and specific examples thereof have been shown by way of example in the drawings and are herein described in detail. It should be understood, however, that the disclosed embodiments are not to be limited to the particular forms or methods disclosed, but to the contrary, the disclosed embodiments are to cover all modifications, equivalents, and alternatives.

What is claimed is:

1. An information modeling system, comprising:
a data interface for receiving data from a data source, wherein the data source corresponds to one or more unique applications;
a computational engine system for parsing a user query; and
a user interface for presenting a result based upon the received data and the parsed user query.

2. The information modeling system of claim 1, wherein said data interface is configured to receive the query and to present the result responsive to the query.

3. The information modeling system of claim 1, wherein said data interface is configured to receive at least one of structured data and unstructured data from the data source.

4. The information modeling system of claim 3, wherein the structured data includes metadata that describes a nature of the structured data.

5. The information modeling system of claim 3, wherein the unstructured data is received in free form with a limited amount of information about the unstructured data.

6. The information modeling system of claim 1, wherein said computational engine system is configured to identify one or more entities and one or more corresponding properties of the entities from the parsed user query.

7. The information modeling system of claim 6, wherein the identified entities are assigned a unique identifier that is maintained across the data source.

8. The information modeling system of claim 1, wherein the information modeling system models the received data to at least one of provide a modular construction of new information groupings of the received data, increase an ability to locate information within the received data, provide a computational transformation of the received data, and support pivot browsing of the modeled data.

9. An information modeling method, comprising:
receiving data from a data source, wherein the data source corresponds to one or more unique applications;
parsing a user query to identify one or more entities; and
presenting a result based upon the received data and the parsed user query, wherein the result is determined by relationships between the identified entities and the received data.

10. The method of claim 9, further comprising receiving a query, wherein said presenting includes presenting the result responsive to the query.

11. The method of claim 9, wherein said receiving includes at least one of receiving structured data from the data source and receiving unstructured data from the data source.

12. The method of claim 9, further comprising modeling the received data.

13. The method of claim 12, further comprising identifying corresponding properties of the identified entities.

14. The method of claim 12, further comprising assigning a unique identifier to the identified entities.

15. The method of claim 12, wherein said modeling comprises at least one of:
providing a modular construction of new information groupings of the received data;
increasing an ability to locate information within the received data,
providing a computational transformation of the received data, and
supporting pivot browsing of the modeled data.

16. A computer program product for modeling information, comprising:
instruction for receiving data from a data source; and
instruction for presenting a result based upon the received data.

17. The computer program product of claim 16, further comprising instruction for receiving a query, wherein said instruction for presenting includes instruction for presenting the result responsive to the query.

18. The computer program product of claim 16, wherein said instruction for receiving includes at least one of instruction for receiving structured data from the data source and instruction for receiving unstructured data from the data source.

19. The computer program product of claim 16, further comprising instruction for modeling the received data.

20. The computer program product of claim 19, wherein said instruction for modeling comprises at least one of:
instruction for providing a modular construction of new information groupings of the received data;
instruction for increasing an ability to locate information within the received data,
instruction for providing a computational transformation of the received data, and
instruction for supporting pivot browsing of the modeled data.
